(19) United States
(12) Patent Application Publication
(10) Pub. No.: US 2015/0235289 A1
(43) Pub. Date: Aug. 20, 2015

(54) COMPUTER SYSTEM AND METHODS FOR CHAT ENABLED ONLINE SEARCH

(71) Applicant: Leo Jeremias, Los Angeles, CA (US)

(72) Inventor: Leo Jeremias, Los Angeles, CA (US)

(21) Appl. No.: 14/703,783

(22) Filed: May 4, 2015

Related U.S. Application Data
(63) Continuation-in-part of application No. 14/293,930, filed on Jun. 2, 2014.
Application No. 14/293,930 is a continuation-in-part of application No. 13/474,633, filed on May 17, 2012.
(60) Provisional application No. 62/095,708, filed on Dec. 22, 2014.
(60) Provisional application No. 62/106,229, filed on Jan. 22, 2015.

(51) Int. Cl. G06Q 30/06; H04L 12/58; G06F 17/30

(52) U.S. Cl. CPC G06Q 30/0613; G06F 17/30864; H04L 51/046; G06Q 30/0625; G06Q 30/0641

(57) ABSTRACT

A computer system includes a network interface configured to communicate with a plurality of user devices and at least one server implementing an internet search engine, memory configured to store information related to a plurality of users of the computer system, an interactive chat module stored in memory and configured to be executed to establish chat based communication between a first user of the computer system and at least a second user of the computer system, a search engine module stored in memory and configured to be executed to provide search queries received at the computer system to remote search engines and further configured to process received search results from the remote search engine, and a processor. The processor is configured to cause the user device to display search results and chat options based on location and identifying expert users.

### CROSS-REFERENCE TO RELATED APPLICATIONS

This application is a continuation-in-part of application Ser. No. 14/293,930, filed Jun. 2, 2014, which is a continuation-in-part of application Ser. No. 13/474,633, filed May 17, 2012, the entireties of which are hereby incorporated by reference. This application claims the benefit of U.S. Provisional Application No. 62/106,229, filed Jan. 22, 2015, and U.S. Provisional Application No. 62/095,708, filed Dec. 22, 2014, the entireties of which are hereby incorporated by reference.

### BACKGROUND

The present disclosure generally relates to the field of online marketplaces and search results. Conventional online shopping typically occurs by a user typing a product name or product description into a search engine. The search engine conventionally provides a list of results and the user is required to click into each particular vendor's website to view product offerings and availability. In some cases, the search engine or another aggregation provider can consolidate ratings for merchants and various pricing or availability information relating to particular product numbers. In such examples, the users still must click into the vendor's website to see the real story (e.g., whether the product is still in stock, whether a particular size or color is available, what the actual price is, shipping costs, etc.).

What is needed are systems and methods for facilitating efficient and rich consumer-to-vendor interactions. What is needed is a chat driven online marketplace system.

### SUMMARY

One embodiment relates to a computer system. The computer system includes a network interface configured to communicate with a plurality of user devices and at least one server implementing an internet search engine, memory configured to store information related to a plurality of users of the computer system, an interactive chat module stored in memory and configured to be executed to establish chat based communication between a first user of the computer system and at least a second user of the computer system, a search engine module stored in memory and configured to be executed to provide search queries received at the computer system to remote search engines and further configured to process received search results from the remote search engine, and a processor. The processor is configured to receive a search query from a graphical user interface of the first user running on a first user device of the plurality of user devices, the search query received at the network interface and provided to the processor and format the search query and transmit the search query to at least one remote search engine using the network interface and according to the search engine module. The processor is further configured to receive search results from the search engine via the network interface and format instructions for the display of the search results in the graphical user interface of the first user. The processor is also configured to transmit, using the network interface, the instructions to the first user device for the display of the search results in the graphical user interface and wherein the instructions include instructions for the display of a chat option on the graphical user interface to chat with one or more other users based on the search query, and transmit, using the network interface, further instructions formatted through execution of the interactive chat module to cause the display of a chat session between the user providing the search query and the one or more other users based on a user selected chat option. The chat option includes an option to chat with other users of the computer system which are located within a predetermined distance from the first user, and the chat option identifies other users who are designated experts by the computer system which respect to one or more keywords included in the search query of the first user.

Another embodiment relates to a computer-implemented method including receiving, at a network interface of a computer, a search query from a user via a graphical user interface running on a user device as implemented according to instructions sent from the server to the user device via the network interface. The method further includes identifying keywords included in the search query and formatting the search query for transmission to one or more remote servers implementing a search engine using a search engine module included in the computer, and transmitting to the one or more remote servers implementing a search engine the formatted search query using the network interface. Additionally, the method includes receiving, using the network interface, search results from the one or more remote servers implementing a search engine, and transmitting, using the network interface, instructions to the user device for the display of the search results in the graphical user interface and wherein the instructions include instructions for the display of at least one chat option on the graphical user interface to chat with one or more other users based on the search results and based on the identified keywords included in the search query. The method also includes receiving, using the network interface, a user selection of a chat option from the user device, and transmitting, using the network interface, further instructions to the user device, the further instructions formatted through execution of the interactive chat module by the computer to cause the display of a chat session between the user and one or more other users based on the user selected chat option. The chat option includes an option to chat with other users of the computer system which are located within a predetermined distance from the first user, and the chat option identifies other users who are designated experts by the computer system with respect to the identified keywords included in the search query.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The disclosure will be more fully understood from the following detailed descriptions, taken in conjunction with the accompanying figures, wherein like reference numerals refer to like elements, in which:

FIG. 1A is a block diagram of an online marketplace system, according to an exemplary embodiment;

FIG. 1B is a block diagram of an online marketplace system, according to another exemplary embodiment;

FIG. 1C is a block diagram of an online marketplace system, according to another exemplary embodiment;

FIG. 1D is a block diagram of an online marketplace system, according to another exemplary embodiment;

FIG. 1E is a block diagram of an online marketplace system, according to another exemplary embodiment;

FIG. 2 is a more detailed block diagram of the client and vendor of the online marketplace system of FIGS. 1A-D, according to an exemplary embodiment;

FIG. 3 is a detailed block diagram of the marketplace server of the online marketplace system of FIGS. 1A-D, according to an exemplary embodiment;

FIG. 4A is a detailed block diagram of the search engine module of the marketplace server of FIG. 3, according to an exemplary embodiment;

FIG. 4B is a detailed block diagram of the vendor account module of the marketplace server of FIG. 3, according to an exemplary embodiment;

FIG. 5 is an example graphical user interface for displaying search results for the online marketplace system, according to an exemplary embodiment;

FIG. 6 is an example graphical user interface for providing a chat interface for the online marketplace system, according to an exemplary embodiment;

FIG. 7 is an example graphical user interface for providing a bidding interface for the online marketplace system, according to an exemplary embodiment;

FIG. 8 is an example graphical user interface for providing a feedback interface for the online marketplace system, according to an exemplary embodiment;

FIG. 9 is a flow chart of a process for providing search results to a user of the online marketplace system, according to an exemplary embodiment;

FIG. 10 is a flow chart of a process for providing a chat interface to a user and vendors of the online marketplace system, according to an exemplary embodiment;

FIG. 11 is a flow chart of a process for providing a bidding interface to a user and vendors of the online marketplace system, according to an exemplary embodiment;

FIG. 12 is a flow chart of a process for providing search results to a user of the online marketplace system, according to another exemplary embodiment;

FIG. 13 is a flow chart of a process for providing a bidding interface in response to a user offer to a user and vendors of the online marketplace system, according to an exemplary embodiment;

FIG. 14 is a flow chart of a process for offer authorization of the online marketplace system, according to an exemplary embodiment;

FIG. 15 is a flow chart of a process of providing a chat interface for users of the online marketplace system, according to an exemplary embodiment;

FIG. 16 is an example graphical user interface for providing a chat interface for users of the online marketplace system, according to an exemplary embodiment;

FIG. 17 is an example graphical user interface for providing a chat interface for users of the online marketplace system, according to an exemplary embodiment;

FIG. 18 is a flow chart of a process of displaying search results and providing chat options for users of the online marketplace system, according to an exemplary embodiment;

FIG. 19 is an example graphical user interface for displaying search results and chat options for users of the online marketplace system, according to an exemplary embodiment;

FIG. 20 is an example graphical user interface for displaying chat rooms for users of the online marketplace system, according to an exemplary embodiment;

FIG. 21 is an example graphical user interface for providing a chat interface for users of the online marketplace system, according to an exemplary embodiment;

FIG. 22 is a flow chart of a process for providing a chat room for users of the online marketplace system, according to an exemplary embodiment; and

FIG. 23 is an example graphical user interface for providing a chat room for users of the online marketplace system, according to an exemplary embodiment.

FIG. 24 is an illustration of a home page generated on a user device according to instructions from a computer according to one embodiment.

FIG. 25 is an illustration of a search results page generated on a user device according to instructions from a computer according to one embodiment.

FIG. 26 is an illustration of a chat page generated on a user device according to instructions from a computer according to one embodiment.

FIG. 27 is an illustration of a chat list page generated on a user device according to instructions from a computer according to one embodiment.

FIG. 28 is an illustration of a friends page generated on a user device according to instructions from a computer according to one embodiment.

FIG. 29 is an illustration of a user profile page generated on a user device according to instructions from a computer according to one embodiment.

FIG. 30 is an illustration of an events page generated on a user device according to instructions from a computer according to one embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for providing an online marketplace to a user and vendors is described. A user may use the online marketplace system to search for products and services, to chat with vendors providing the products and services, to chat with other users based on the searched products and services, and to purchase the products and services. The user may first provide a search query to a search engine via an interface (e.g., via an app on a mobile device, via a browser on a computer, etc.). After the user receives the search results, the user may select one or more results or vendors associated with the results. The user can then chat with the selected vendor without requiring the user to browse to the vendor's website. For example, the search results page itself or a plug-in on top of the search page may allow the user to initiate the chat. Systems or methods constructed or provided according to some embodiments of the present disclosure advantageously permit the user to rapidly obtain person-to-person feedback without requiring the user to visit website pages for each vendor in a serial manner.

In some embodiments, the user may chat with other users based on the search query. For example, after the user receives the results of the search query, the user may also receive an indication of other users searching the same or substantially the same query. In addition to chatting with a selected vendor, the user may also chat with another user who used the similar search query, without requiring the user to browse to a vendor's website. Accordingly, the systems and methods provided herein permit users using similar search queries to exchange information without searching several vendor website for the desired product or service (e.g., “Vendor X does not provide Product A, as I searched. However, Vendor Y does provide Product A.”). As such, the collective knowledge of other users may be utilized to enhance one's search for products and services.

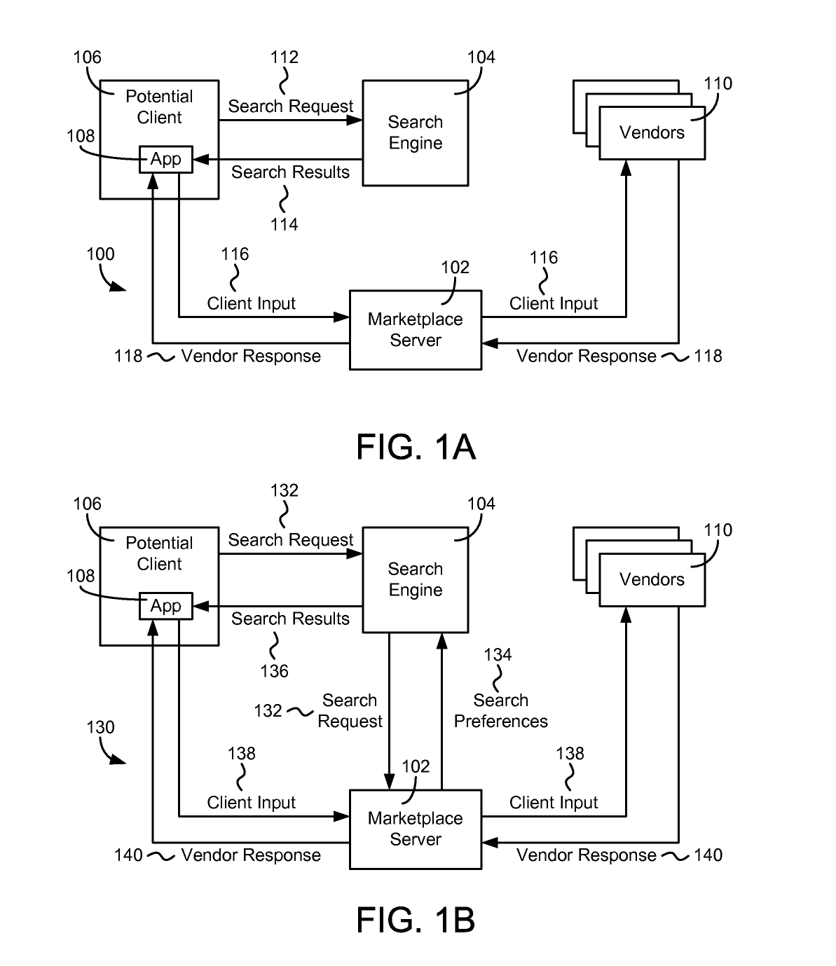

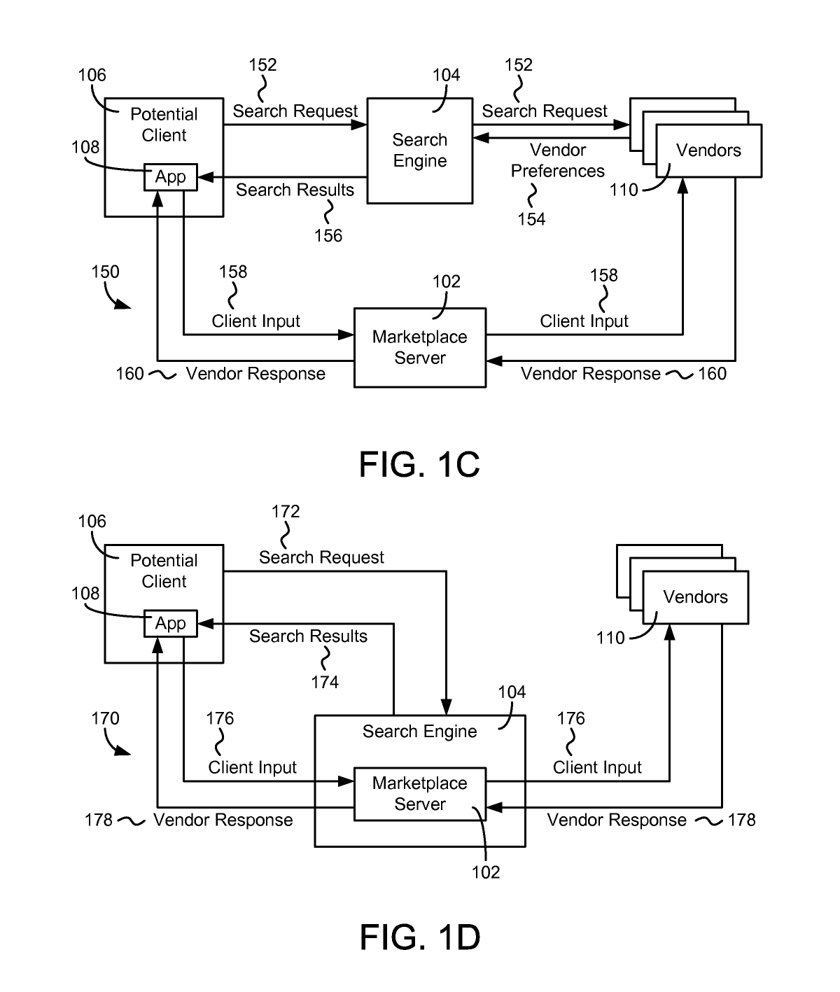

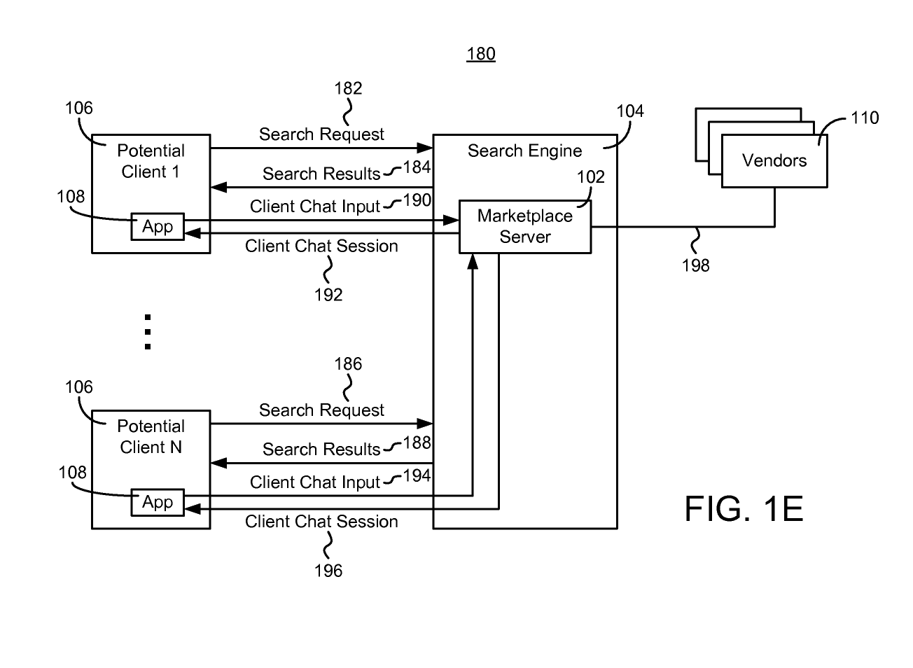

Referring to FIGS. 1A-D, online marketplace systems are shown, according to various exemplary embodiments. Online marketplace systems 100, 130, 150, 170 of FIGS. 1A-D generally include a marketplace server 102, search engine 104, a potential client 106, and vendors 110. Potential client 106 may provide a search request to search engine 104 and receive search results from search engine 104. Search engine 104 may be a single search engine, more than one search engine, or a search engine that aggregates search results from multiple other search engines. Potential client 106 may be connected to marketplace server 102. Marketplace server 102 may receive search results, client input, and other information from potential client 106. Marketplace server 102 may then provide client input to the one or more vendors 110 and provide a response from vendors 110 to potential client 106. In other words, marketplace server 102 is configured to facilitate interaction, such as a chat, between potential client 106 and vendors 110. Marketplace server 102 may also be configured to facilitate an interaction, such as a chat, between several potential clients 106 (see FIG. 1E). The interaction between potential client 106, vendors 110, marketplace server 102, and search engine 104 may vary as shown in FIGS. 1A-D or otherwise. In varying embodiments, an interactive session may be a chat session (e.g., SMS, instant messaging, texting, etc.), a voice over-IP session, a Skype session, a video conference session, or another interactive computer-based communication session.

Referring now to FIG. 1A, one exemplary configuration of online marketplace system 100 is shown. Online marketplace system 100 includes a marketplace server 102, search engine 104, a potential client 106, and one or more vendors 110. Marketplace server 102 may be configured to manage interaction between client 106 and vendors 110. In the embodiment of FIG. 1A, potential client 106 may provide a search request 112 to search engine 104, and receives search results 114. Potential client 106 may view the search results via application 108 (e.g., an application on a mobile device, a browser on a computer or laptop, etc.). In the embodiment of FIG. 1A, the activity of search engine 104 is shown independent of marketplace server 102 activity. In such an embodiment, marketplace server 102 may be configured to manage interaction between potential client 106 and vendors 110 without directly communicating with the search engine that potential client 106 uses to select vendors 110. The embodiment of FIG. 1A may operate with the assistance of application 108 (e.g., browser plug-in) that parses search results for facilitating the chat-based marketplace activity.

The user may select one or more search results or vendors associated with the search results using application 108. The selections and other client input 116 may be provided to marketplace server 102. Marketplace server 102 may use the selection of the search results and vendors to contact the vendors (e.g., to establish an on-demand chat session). Marketplace server 102 may provide the client input 116 (e.g., input chat text) to vendors 110 and may provide vendor responses 118 (e.g., chat responses, acceptance of the chat session, etc.) to client 106 (e.g., via app 108). For example, if client input 116 indicates that potential client 106 is interested in a product of a vendor 110, vendor 110 may receive client input 116 and indicate via vendor response 118 whether the vendor is available to chat with potential client 106. As another example, if client input 116 indicates that potential client 106 is interested in receiving an offer from vendor 110, vendor 110 may receive client input 116 and indicate whether the vendor can provide an offer. The vendor may provide the offer as part of a vendor response 118 to potential client 106 via marketplace server 102.

Vendors 110 may provide vendor information to marketplace server 102. Online marketplace system 100 may be a subscription-based system and marketplace server 102 may use information received from the vendor to authenticate a vendor 110. Marketplace server 102 may further charge vendors 110 for participating in the online marketplace system, allow vendors to provide preferences relating to the display of search results related to vendors 110, and otherwise manage vendor 110 usage of the online marketplace system.

Referring now to FIG. 1B, another exemplary configuration of an online marketplace system 130 is shown, according to an exemplary embodiment. After potential client 106 provides a search request 132 to search engine 104, marketplace server 102 may receive search request 132. Marketplace server 102 may then provide search preferences 134 to search engine 104 which may be used by search engine 104 to determine which search results 136 to provide to potential client 106. For example, search preferences 134 may include a preferred vendor. If a vendor 110 has subscribed to the online marketplace system, search results associated with the vendor may be listed at the top of search results 136. As another example, search preferences 134 may include vendors that are participating in the online marketplace system. Search engine 104 may use the list of vendors to determine which search results to provide to potential client 106. In other words, search results 136 provided to potential client 106 are impacted by the activity of marketplace server 102, which works in conjunction with search engine 104. Potential client 106 may then view search results 136 via application 108. Client input 138 may be provided to vendors 110 via marketplace server 102, and the vendor response 140 may be provided to potential client 106 by marketplace server 102, as described above, to initiate a chatting or bidding process between client 106 and vendors 110. For example, client input 138 may include a client question or comment posted in the chat interface, and vendor response 140 may include a response to the client question or comment. Marketplace server 102 may facilitate continuous communication between client 106 and vendors 110.

Referring now to FIG. 1C, another configuration of an online marketplace system 150 is shown, according to an exemplary embodiment. After potential client 106 provides a search request 152 to search engine 104, vendors 110 may receive the search request. Vendors 110 may provide vendor preferences 154 to search engine 104, and search engine 104 may use vendor preferences 154 to determine which search results 156 to provide to potential client 106. Vendor preferences 154 may include if the vendor is a preferred vendor (e.g., a vendor whose search results affiliated with the vendor are shown at the top of the search results), if the vendor is a participant in the online marketing system, if the vendor is available to chat with client 106, etc. Search results 156 may be sorted based on vendor preferences 154. Potential client 106 may then view search results 156 via application 108. In other words, search results 156 provided to potential client 106 are impacted by vendor preferences related to the online marketplace system described in the present disclosure. Client input 158 may be provided to vendors 110 via marketplace server 102, and the vendor response 160 may be provided to potential client 106 by marketplace server 102, as described above, to initiate a chatting or bidding process between client 106 and vendors 110. For example, client input 158 may include a client question or comment posted in the chat interface, and vendor response 160 may include a response to the client question or comment. Marketplace server 102 may facilitate continuous communication between client 106 and vendors 110.

Referring now to FIG. 1D, another configuration of an online marketplace system 170 is shown, according to an exemplary embodiment. In the embodiment of FIG. 1D, search engine 104 is shown to include marketplace server 102. Search engine 104 may include marketplace server 102 in the process of finding and delivering search results to potential client 106. In other words, marketplace server 102 is a search engine itself or functions with search engine 104 as a search engine independent of all other search engines. Search engine 104 uses results and information from marketplace server 102 to provide search results 174 to client 106 without using information from other search engines. In the embodiment of FIG. 1D, marketplace server 102 uses information related to the vendors subscribed or affiliated with marketplace server 102 and the products and services the vendors provide to determine appropriate search results 174 for a given search request 172. In such an embodiment, marketplace server 102 may include one or more modules for comparing search request 172 to vendors and vendor offers to determine appropriate search results 174.

Search engine 104, upon receiving a search request 172 from potential client 106, provides the request to marketplace server 102. Marketplace server 102 may determine which search results to provide or highlight compared to other search results. Potential client 106 may then receive search results 174 and view search results 174 via application 108. Client input 176 may be provided to vendors 110 via marketplace server 102, and the vendor response 178 may be provided to potential client 106 by marketplace server 102, as described above, to initiate a chatting or bidding process between client 106 and vendors 110. For example, client input 176 may include a client question or comment posted in the chat interface, and vendor response 178 may include a response to the client question or comment. Marketplace server 102 may facilitate continuous communication between client 106 and vendors 110.

Referring to FIG. 1E, another configuration of an online marketplace system 180 is shown, according to an exemplary embodiment. Marketplace system 180 may include the communications described above and herein between potential client 106 and vendors 110 (e.g., client input 176 and vendor response 178 of FIG. 1D). For clarity, these communications are lumped together in the potential client and vendor communication 198. In the embodiment of FIG. 1E, search engine 104 is shown to include marketplace server 102. According to various other embodiments, marketplace server 102 and search engine 104 may be structured as shown in FIGS. 1A-1D, and many other ways. Although described as a client chat session (e.g., client chat session 192), these chat sessions may also be referred to as user chat sessions herein.

As shown, online marketplace system 180 communicates with potential client1 106 to potential clientn 106. As in FIGS. 1A-1D, each potential client 106 may communicate with search engine 104, marketplace server 102, and vendors 110 via application 108. In this example embodiment, potential client1 106 provides a search quest 182 to search engine 104. Search engine 104 generates and provides search results 184 based on the request 182. Potential clientn 106 may also provide a search request 186 to search engine 104, where search engine 104 provides search results 188 based on the results. These operations may be similar to that of FIGS. 1A-1D.

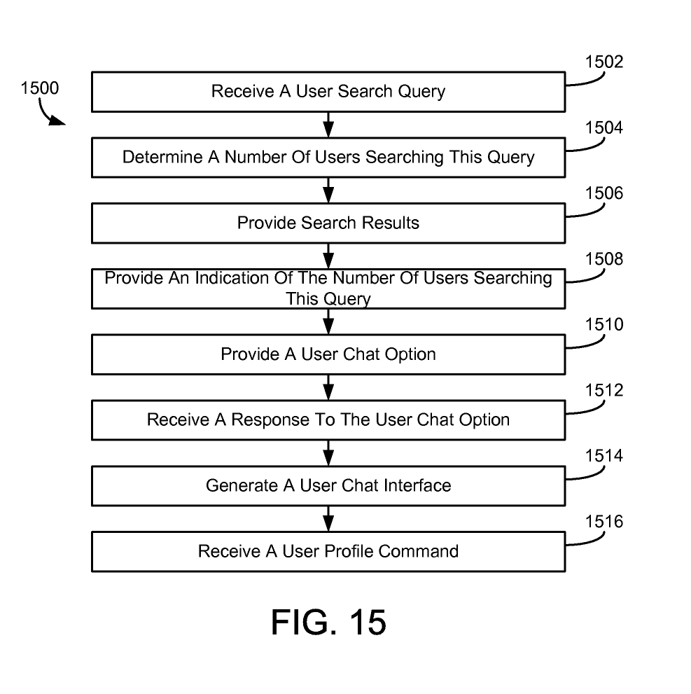

Marketplace server 102 may also provide chat options to the potential clients 106. The chat options may be included with the search results. The chat options may be configured to enable marketplace server 102 to generate a chat session between potential client1 106 and another potential client based on the search query. Potential client1 106 may control the chat options via client chat input 190. Via client chat input 190, potential client1 106 may select which one or more chat options to use. Marketplace server 102 generates client chat session 192 based on the selected chat option from client chat input 190. As described more fully with regard to FIG. 15, the chat options may be based on the location of potential client1 106, a location selected by potential client1 106, a search request of other potential clients, a peer-to-peer option, and a group-based option.

As an example, potential clientn 106 provides search request 186. Search request 186 is substantially similar to search request 182. Similarity may be based on a matching of words, letters, and/or phrases. The matching may be further based on the order of the words, letters, and/or phrases. As similarity can be widely based, a limitless amount of determinations may be used to gauge matching. For example, potential client1 106 searches “green hats and green gloves” (search request 182). Potential clientn 106 searches “hats and gloves” (search request 186). Because both searches relate to “hats and gloves,” marketplace server 102 may determine that they are substantially similar. As such, when marketplace server 102 provides search results 184, search results 184 may include the number of other users searching substantially similar items (in this example, one other user). Potential client1 106 may wish to chat with that other user and enter this desire via client chat input 190. Potential clientn 106 may also wish to chat with the other user and enter this desire via client chat input 194. Marketplace server 102 may then generate a chat session for potential client1 106 and potential clientn 106, which is provided as client chat session 192 and client chat session 196, respectively. Thus, based on the search parameters, potential clients are given the opportunity to interact with one another from marketplace server 102. The potential clients may share experiences, their profiles (described below), and any other information. In one embodiment, the user chat session is provided without requiring the user to browse away from the list of search results.

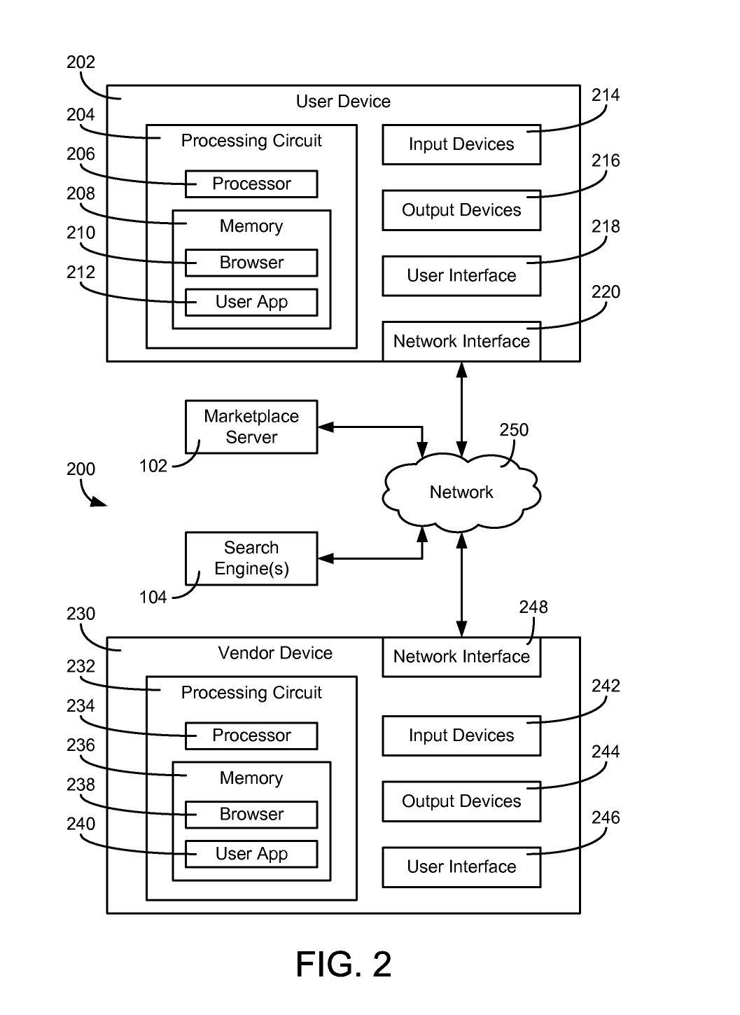

Referring now to FIG. 2, a user device 202 and vendor device 230 for potential client 106 and vendors 110 are shown, according to an exemplary embodiment. Clients and vendors may be connected to marketplace server 102 and search engines 104 via network 250. Clients and vendors may use user device 202 and vendor device 230 to access the online marketplace system described herein (e.g., the online marketplace system of FIGS. 1A-D, referred to collectively as online marketplace system 200 in FIG. 2).

Online marketplace system 200 includes a user device 202. User device 202 may be, for example, a computer, laptop, mobile phone, PDA, or other computing device that provides information to the client or user of user device 202 relating to online marketplace system 200. The user may view search results, select search results and vendors, converse with vendors, and select offers for purchase using user device 202.

User device 202 includes a processing circuit 204 including a processor 206 and memory 208 for completing the various user or client processes of the present disclosure. Processor 206 may be implemented as a general purpose processor, an application specific integrated circuit (ASIC), one or more field programmable gate arrays (FPGAs), a group of processing components, or other suitable electronic processing components. Memory 208 may be one or more devices (e.g., RAM, ROM, flash memory, hard disk storage, etc.) for storing data and/or computer code for completing and/or facilitating the various user or client processes, layers, and modules described in the present disclosure. Memory 208 may be a non-transitory medium or include volatile memory or non-volatile memory. Memory 208 may include database components, object code components, script components, or any other type of information structure for supporting the various activities and information structures of the present disclosure. Memory 208 may be communicably connected to processor 206 and includes computer code or instructions for executing one or more processes described herein.

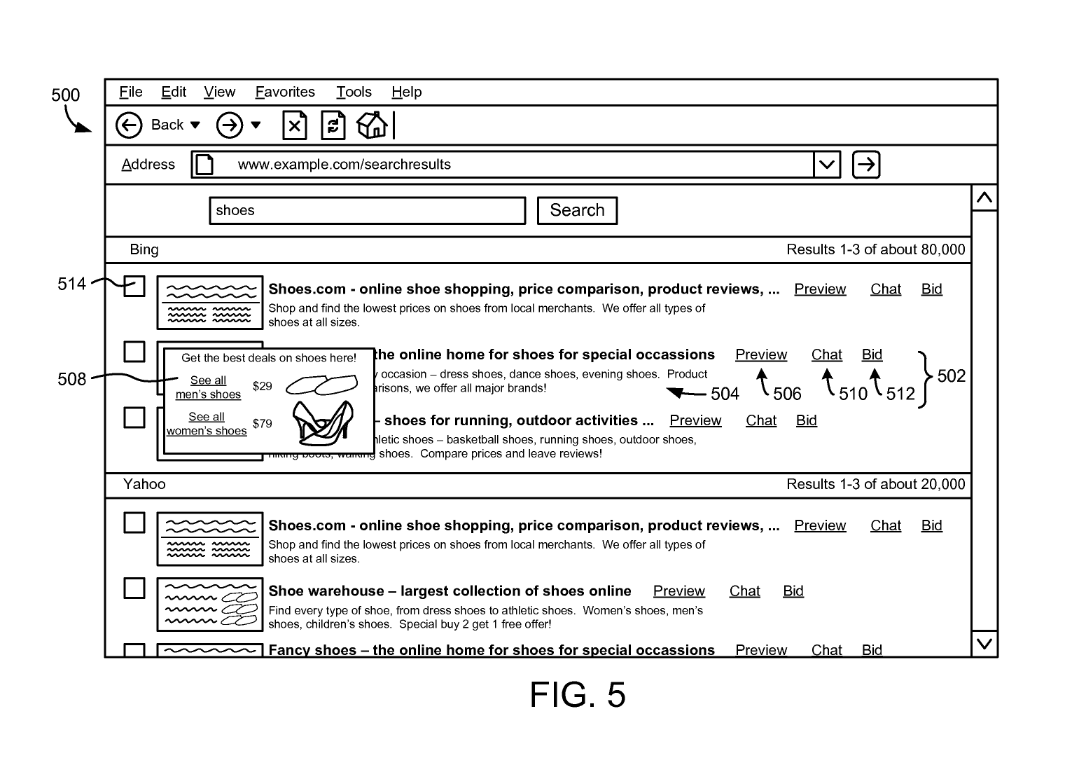

Memory 208 is shown to include a browser module 210 and user app module 212. Browser module 210 may be configured to provide a software application for viewing search results and interacting with a chat interface and bidding interface. Browser module 210 may be used with the user is accessing system 200 on a laptop, desktop, or a mobile device that does not have or support a particular app for interfacing with system 200. User app module 212 may similarly provide an application for viewing search results and interacting with a chat interface and bidding interface. User app module 212 is configured to provide an application on, for example, a mobile phone or other handheld device. Memory 208 may include only one of browser module 210 and user app module 212, or may include both. As examples, the embodiments shown in FIGS. 5-8 are examples of applications provided by browser module 210. In various embodiments, elements of the screenshots of FIGS. 5-8 may be shown on either type of client (e.g., a browser-based client or an application-based client).

User device 202 further includes network interface 220. Network interface 220 may be configured to communicate with marketplace server 102 and search engines 104 via one or more networks 250 (e.g., a mobile phone network, the Internet, etc.). Input devices 214 may include any input device (e.g., keyboard, mouse, phone keypad, touchscreen, etc.) that may be used by a user of device 202 to interact with marketplace server 102 and vendor device 230. Output devices 216 may include display screens, monitors, speakers, and/or other visual and audio components for providing a user of device 202 with vendor information and search result information. User interface 218 can be any control, pointer, keypad, sensor, or sensors configured to accept user input relating to interaction between the user and vendor. It should be appreciated that some user devices 202 (e.g., full computers) will include many input devices 214, output devices 216, or user interfaces 218 while other user devices 202 (e.g., a touchscreen-based mobile phone) will primarily have a single touchscreen display for all user input/output activities.

Vendor device 230 may be, for example, a computer, laptop, mobile phone, PDA, or other computing device that provides the vendor access to the online marketplace system. The vendor may receive information relating to clients interested in the vendor, and the vendor may interact with the clients using vendor device 230. Vendor device 230 includes a processing circuit 232 including a processor 234 and memory 236. Processing circuit 232, processor 234, and memory 236 may have the same functionality as described with reference to processing circuit 204, processor 206, and memory 208. Memory 236 includes browser module 238 and user app module 240 that provides an application that allows the vendor to view client information (e.g., if a client is interested in a product or service of the vendor) and to converse with the client (e.g., chatting with the client or providing an offer to the client). Vendor device 230 further includes input devices 242, output devices 244, user interface 246, and network interface 248. Components 242-248 may have the same functionality as described with reference to components 214-220 of user device 202.

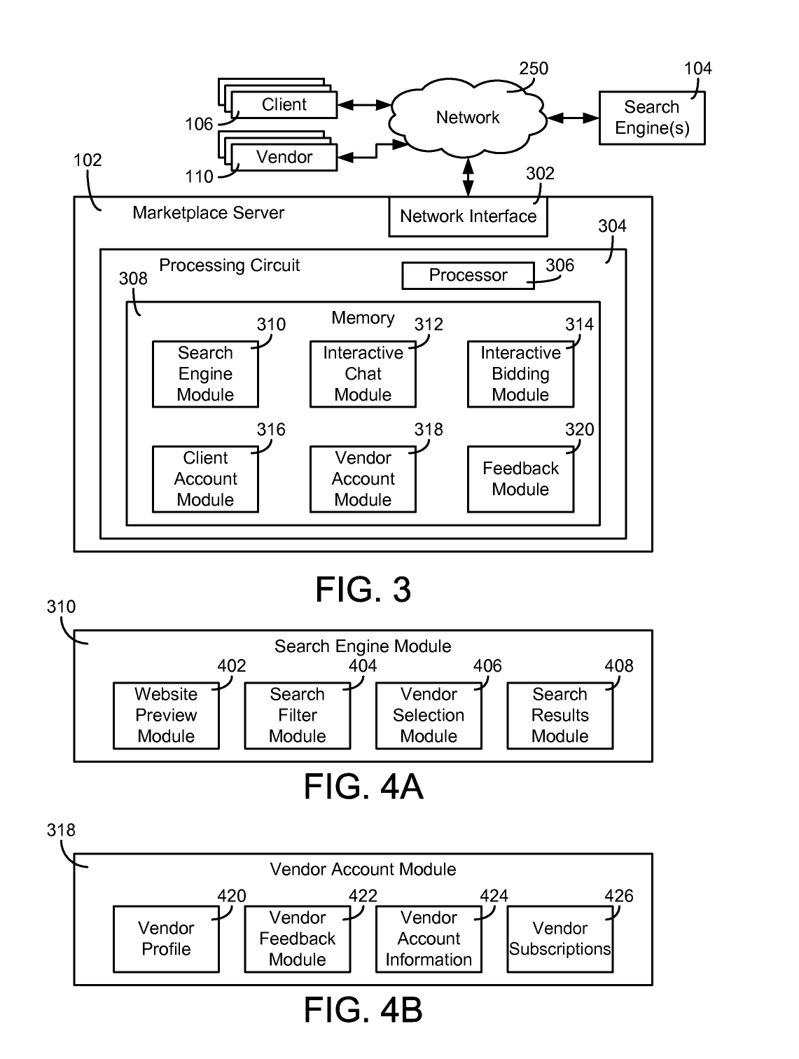

Referring now to FIG. 3, marketplace server 102 is shown in greater detail. Marketplace server 102 may be connected to search engines 104, clients 106, and vendors 110 via network interface 302 and network 250. Network interface 302 may be configured to communicate (e.g., wirelessly or non-wirelessly) with search engines 104, clients 106, and vendors 110 via network 250. Marketplace server 102 including a processing circuit 304 including a processor 306 and memory 308. Processing circuit 304, processor 306, and memory 308 may be configured as described above with reference to the processing circuits, processors, and memory of FIG. 2.

Memory 308 includes various modules for completing the processes described herein. Memory 308 includes a search engine module 310 configured to receive search results and other information from a search engine or other source and format the search results for the clients. Memory 308 further includes an interactive chat module 312 configured to manage a chat interface that a client and one or more vendors may use to communicate with one another. The interactive chat module 312 may also support a chat interface between clients that the clients may use to communicate with each other. Memory 308 further includes an interactive bidding module 314 configured to manage an interface that allows vendors to submit bids to a client and clients to select bids for purchase. Memory 308 further includes a client account module 316 and vendor account module 318 configured to manage client and vendor interaction with marketplace server 102. Memory 308 further includes feedback module 320 configured to manage vendor feedback provided by clients.

Referring also to FIG. 4A, the activities of search engine module 310 are shown in greater detail. Search engine module 310 may be configured to receive search results and other information from a search engine or client device. Search engine module 310 may then format the search results for the client and provide the formatted search results to the client for display (e.g., on browser module 210 or user app module 212). Search engine module 310 may further manage client interaction with the search results by providing links to preview images for the websites and chat windows for interaction between the client and vendors. Search engine module 310 includes a website preview module 402, search filter module 404, vendor selection module 406, and search results module 408 for formatting the search results for the client.

In the embodiments of FIGS. 3 and 4A, search engine module 310 is shown as part of marketplace server 102. In other embodiments, some or all of the functionality provided by search engine module 310 may be executed on a browser module or user app module of a client device as shown in FIG. 2, may be executed by a search engine 104 configured to receive a search request from a client, or otherwise. For example, search engine module 310 may provide instructions to a browser module or user app module of a client device that allows the client device to incorporate the features described herein on the client device (e.g., handling activity on the client side instead of the server side, allowing images, links, and other information to load faster). The instructions may be implemented by, for example, a browser add-on application that is installed on the client device.

Further, search engine module 310 may be a part of marketplace server 102 or another module. For example, in the embodiment of online marketplace system 170 of FIG. 1D, search engine module 310 may be a module within marketplace server 102 and search engine 104 (see also FIG. 1E). As another example, in the embodiment of online marketplace system 130 of FIG. 1B, search engine module 310 receives search results before client 106 does, and formats the search results before they are received by client 106.

In another embodiment, search engine module 310 may be configured to determine search results for a given search request. For example, with reference to online marketplace system 170 of FIG. 1D, marketplace server 102 may be configured to generate search results for a search request. Search engine module 310 may receive the search request and determine the most relevant search results, based on the vendors or vendor offers and the search terms or keywords of the search request.

Website preview module 402 may be configured to generate a preview of a website associated with a search result. Upon receiving search results, website preview module 402 may generate a preview image of the website associated with each search result. In one embodiment, the preview image may be a cached thumbnail image of the website, making it easier for the client browsing the search results to see the contents of the website without clicking on any link. The client may select to view the preview image when the client is presented with the search results. In one embodiment, a link may be provided that the client may select to view the preview image. In another embodiment, the client may simply scroll a mouse over a link to pull up the preview image. In yet another embodiment, the client may scroll a mouse over the link to pull up the preview image, and then select a preview link to update the preview image.

Search filter module 404 may be configured to filter the received search results by removing duplicated search results, highlighting particular search results, and otherwise determining which search results to show. For example, when a client provides a search request to a search engine, results from multiple search engines may be returned to the client. Search filter module 404 may be configured to remove duplicated search results, e.g., search results that were found by two or more search engines. Search filter module 404 may further change the order of search result listings. For example, if a search result is associated with a “preferred” vendor or other vendor that has a subscription with marketplace server 102, then search filter module 404 may list the search result at the top of all search results, highlight the search result, or make any other stylistic change.

Vendor selection module 406 may be configured to manage user selections of vendors from the search results. For example, after being provided with search results, the client may select one or more vendors to participate in a chatting process or bidding process. Vendor selection module 406 may receive the selection of the one or more vendors and may be configured to invite the vendors to reply to the client via the chat interface, or to submit bids via the bidding interface. In one embodiment, for each search result, the client may be provided a link that allows the client to select the vendor. Upon selection of the link, a chat interface may be provided to the client, and a chat interface may simultaneously be provided to a vendor, allowing the client and vendor to chat in one embodiment. In another embodiment, a checkbox or other button may be provided for each search result, and the client may select the search result via the checkbox in order to select one or more vendors to chat with or to receive an offer from. The client may be able to select one vendor at a time or multiple vendors at the same time, for either a chatting or a bidding process (e.g., selecting multiple vendors to chat with at the same time, selecting multiple vendors to invite to a bidding process, etc.).

Search results module 408 may be configured to format each search result for the client. For example, for each search result, search results module 408 may generate links the client may click on. A link may take the client to a preview of the website, may open a chat window that allows the client to chat with the vendor (as described with reference to vendor selection module 406), may open a bidding window that allows vendors to submit bids to the client, etc. Search results module 408 may further determine which content is displayed for each search result (e.g., the short description of the search result or vendor, which links or preview images to include). In other words, search results module 408 uses the information from modules 402-406 and other information to generate a search result listing for the client.

The search results may be presented in various ways. For example, module 408 may be configured to provide text search results (e.g., a title and description for each search result). As another example, module 408 may generate visual search results. The search results may be icon based (e.g., each search result is represented by an icon), window based (e.g., each search result is represented by a window showing a website's homepage and other information), may be 3D (a three-dimensional representation of the search results), or may be based on the type of search the client is requesting. For example, if the client is searching for blogs, a tiled 3D view may be used to display the search results, allowing the client to scroll through screenshots of websites associated with the search results. Search results module 408 may be configured to determine a type of presentation for the search results and to provide the client device receiving the search results with the presentation.

Interactive chat module 312 may be configured to manage a chat interface between a client and one or more vendors. Interactive chat module 312 may receive an indication from a client that the client wishes to initiate a chat with one or more vendors. The indication may come from a client clicking a chat link provided with a search result, according to one embodiment. After receiving the indication, a chat window may be provided on the website the client is viewing. The process of displaying the chat window for the client may vary, according to various embodiments. The chat interface may be provided on the same website the client is browsing the search results on or the chat window may be loaded for the client on a new website. As an example, a chat window may pop up on the current webpage the client is browsing. As another example, the chat window may pop up on the current webpage the client is browsing, but only after the vendor has responded and provided an initial message. As yet another example, a chat window may be part of the loaded webpage, and upon selection of a link, all future client and vendor interaction may occur in the chat window (e.g., the chat window may be loaded as an empty window on, for example, the right side of the screen, and future chat interaction may be displayed in the window). As yet another example, upon a selection of the chat link, a chat interface may be opened on the webpage directly below the corresponding search result, pushing other search results down the page.

The client may then use the chat interface to type a question or other response for the vendor, and the vendor response may be posted in the chat window as well. In other embodiments, other methods for inputting a question for the vendor or receiving a vendor response may be implemented (e.g., voice input/output). For example, the chat interface may be integrated with voice over IP (VoIP) technology that allows the client and vendors to speak to each other. As another example, while the chat interface is open, the client may call the vendor using a software application (e.g., Skype) to further discuss the product or service with the vendor. In general, this allows the client and a vendor to conduct a conversation regarding a product or service associated with the vendor and the selected search result. A chat interface may be initiated for the client for each vendor, or a chat interface may host a conversation between a client and multiple vendors.

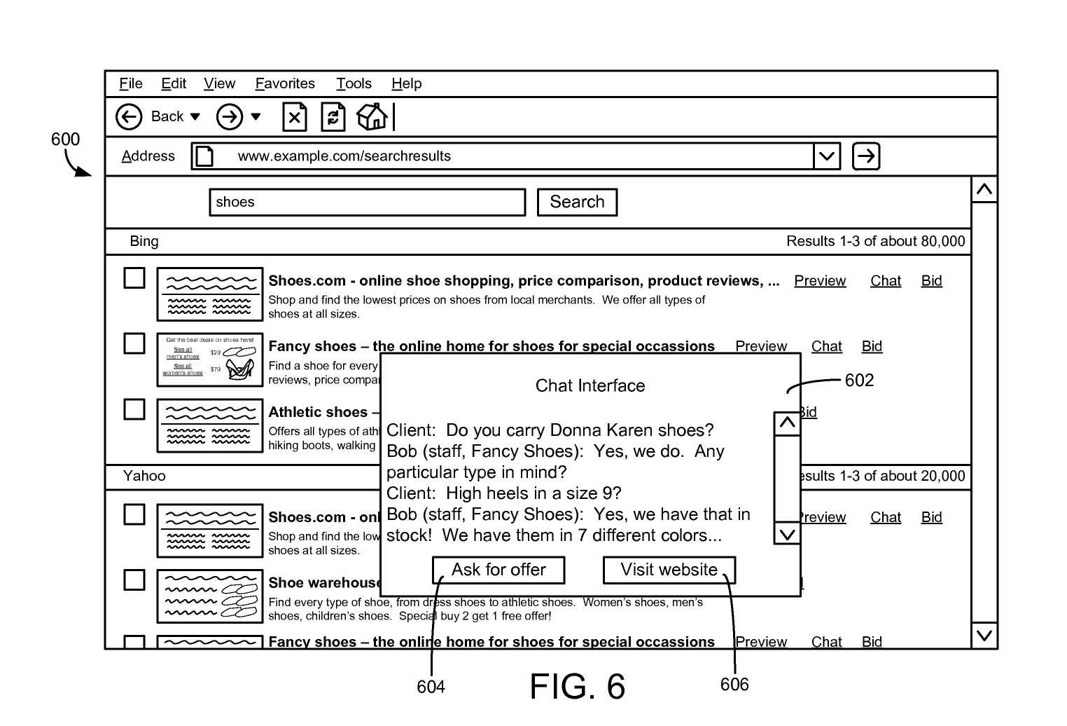

Interactive chat module 312 may be configured to contact the one or more vendors the client is interested in and to provide a chat interface to the vendors. For both the clients and vendors, interactive chat module 312 may be configured to provide the chat interface for various types of devices. Interactive chat module 312 may provide a chat interface for a computer, laptop, smartphone, or other mobile device. Interactive chat module 312 may integrate with various software applications (e.g., Skype), allowing a client or vendor to communicate via the chat interface through the software application. The activities of interactive chat module 312 is described in greater detail with reference to FIG. 6.

Interactive chat module 312 (or another module of marketplace server 102) may further be configured to filter chat interaction between the client and the one or more vendors. Interactive chat module 312 may detect when a vendor is “spamming” the chat window of the chat interface with messages, when a vendor or client is providing inappropriate content, when a vendor is being disruptive, or otherwise. For example, if during a chat, the vendor is spamming the chat window with messages not related to a client query (e.g., a “BUY NOW!!!!” message repeated multiple times without addressing a client question or comment, posting a detailed offer multiple times without addressing a client question or comment, etc.), interactive chat module 312 may terminate the chat (or remove the offending vendor from the chat) or alert the client that the vendor is not cooperating with the chatting system. As another example, if the vendor is providing inappropriate content (e.g., content not related to the search result or a client question or comment) or if the vendor or client is being disruptive (e.g., using foul language), interactive chat module 312 may terminate the chat or alert the client or vendor that the other party in the chat is being inappropriate.

Interactive chat module 312 may also be configured to manage a chat interface between clients. Interactive chat module 312 may receive an indication from a client that the client wishes to initiate a chat with another client. The indication may come from a client clicking a chat link provided with a search result, according to one embodiment. After receiving the indication, a chat window may be provided on the website the client is viewing. The process of displaying the chat window for the client may vary, according to various embodiments. The chat interface may be provided on the same website the client is browsing the search results on or the chat window may be loaded for the client on a new website. As an example, a chat window may pop up on the current webpage the client is browsing. As another example, the chat window may pop up on the current webpage the client is browsing, but only after the vendor has responded and provided an initial message. As yet another example, a chat window may be part of the loaded webpage, and upon selection of a link. As yet another example, upon a selection of the chat link, a chat interface may be opened on the webpage directly below the corresponding search result, pushing other search results down the page.

The client may then use the chat interface to exchange information with one or more other clients. The chat interface provided may be based on a client chat input and the number of users searching the same or substantially the same search parameters. For example, if the client is the only client searching a particular parameter, marketplace server 102 may not provide any client-to-client chat session. However, if more than one client is searching similar parameters, marketplace server 102 may ask each client if they would like to initiate a group chat. If the client chooses yes, the client may also provide input as to whether they want to chat with only one other client, whom they may select (e.g., peer-to-peer); chat with numerous other clients (group chat); chat with users in their or a selected location; and many other ways.

Marketplace server 102 may also update the order of search results (e.g., search results 188 in FIG. 1E) in a subsequent search (e.g., search request 186) based on a number of users of going to a specific site in the list of search results from prior search results. In this manner, a list of search results for certain search parameters become optimized over time based on user traffic. Via group chat of the interactive chat module 312 then, clients may discuss among themselves the efficacy of the search results (e.g., “Although vendor X is listed first, I have found vendor Y (listed fourth) to be more useful.”). Thus, interactive chat module 312 may connect clients to help the effectiveness of their searching.

Interactive bidding module 314 may be configured to manage a bidding process between a client and one or more vendors. Interactive bidding module 314 may receive an indication from a client that the client wishes to receive bids for a product or service from one or more vendors. The client may select all vendors related to the received search results or may select particular vendors and search results. Interactive bidding module 314 may be configured to contact the one or more vendors the client is interested in and to provide a bidding interface to both the client and vendors. The bidding interface may be configured to allow vendors to submit bids and other comments, and allow the client to reject or accept a bid, in addition to posting other comments. Interactive bidding module 314 may receive an indication of an accepted bid and manage the interaction between the client and the vendor of the accepted bid.

As an example of an interaction between a client and vendors via the bidding interface, the client may first invite one or more vendors into the chat window or bidding window. The client may individually select vendors, may choose to select all vendors associated with the first ten or twenty search results, may choose the vendors based on a list of criteria provided by the client to the marketplace server, or may select the vendors in any other way. The client may then provide a product or service (e.g., pair of shoes) that the client wishes to purchase. The vendors may then provide offers (e.g., a vendor may offer a pair of shoes for $40, another vendor then offers the same pair of shoes for $35, and so forth), and other comments, via the bidding interface. The offers may simply include a cost for the offer, or may include additional terms (e.g., free shipping, money-back guarantees, etc.). These additional terms may be provided as a comment by the vendor or integrated with the rest of the offer (e.g., the cost and product). The bidding interface may be configured to present the offer in various formats. For example, the offer may be provided such that if a client clicks on the offer in the bidding interface, the offer is accepted, or the client may click the offer to then choose whether to accept or reject the offer.

As another example of an interaction between a client and vendors via the bidding interface, the client may view a search result for a particular vendor. The client may then choose to provide an offer to the vendor for a product or service. For example, the client may view the search results for a vendor that sells shoes, and the client may provide an offer of $40 for a particular pair of shoes. The client may type out the offer; or one or more links, drop-down boxes, or checkboxes may be provided with the search results that allow the client to select a price or price range, along with a particular brand or type of shoe. After providing the offer to the vendor, the vendor may choose to accept, reject, or counteroffer the offer. Interactive bidding module 314 may then provide a bidding interface to allow the vendor and client to interact with one another, with the initial client offer triggering the bidding process.

The client may review the bids, offers, and comments and may select an offer to accept (e.g., selecting the offer for the $35 pair of shoes). Interactive bidding module 314 may then provide the client and vendor a way to finalize the offer. For example, interactive bidding module 314 may provide a chat interface to the client and vendor of the winning offer to finalize the deal, may boot all non-winning vendors from the bidding interface and allow the client and vendor to chat, etc. Interactive bidding module 314 may then finalize the deal, or the deal may be finalized independently by the client and vendor. In addition to accepting an offer, the client may further boot vendors out of the bidding interface (e.g., vendors with inadequate offers or offers not relevant to the client), invite other vendors to the bidding interface, reject offers, provide reasons for rejections (e.g., the price of the pair of shoes in an offer being too high), or provide further details to the vendors.

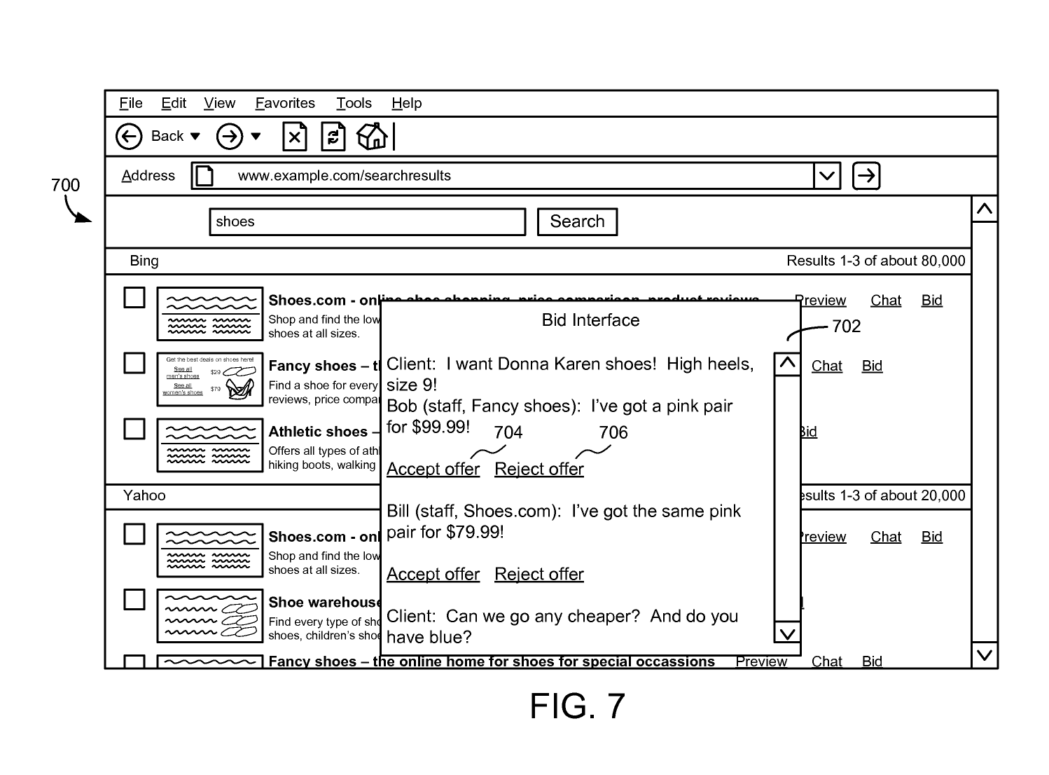

In one embodiment, the bidding interface may be an interface integrated with the chat interface. For example, the client may first initiate a chat with the one or more vendors, then select to start a bidding process with the vendors. The chat interface may then be adjusted to allow offers to be submitted, accepted, and rejected. In another embodiment, upon starting a bidding process, a new bidding interface may be launched independently of the chat interface. The chat interface and bidding interface may be independent interfaces or may be integrated in various ways without departing from the scope of the present disclosure. Further, the bidding interface may be displayed in any manner as described with respect to interactive chat module 312. The activities of interactive bidding module 314 is described in greater detail with reference to FIG. 7.

Like interactive chat module 312, interactive bidding module 314 (or another module of marketplace server 102) may further be configured to filter interaction between the client and the one or more vendors in the bidding process. Interactive chat module 312 may detect when a vendor is “spamming” the bidding window of the bidding interface with offers and messages, when a vendor or client is providing inappropriate content, when a vendor is being disruptive, or otherwise. For example, if during a bidding process, the vendor is spamming the bidding window with the same offer over and over again (e.g., providing the same offer over and over that a client has already rejected), interactive bidding module 314 may remove the vendor from the bidding window and alert the client of the removal.

Client account module 316 may be configured to manage client interaction with marketplace server 102. Marketplace server 102 may provide a chat and bidding interface as described with reference to modules 312, 314, and client account module 316 may be configured to track client usage of the chat interface (with vendors and with other clients) and bidding interface or may track client history relating to interaction with the search results. For example, client account module 316 may manage customer account information or may use customer feedback to adjust the search results (e.g., putting preferred vendors' search results at the top, using bad feedback to remove other vendors' search results). Further, client account module 316 may be configured to manage post-purchase activities. For example, upon purchasing an offer, client account module 316 may be configured to hold client funds in escrow for the vendor, may authorize the client for purchase of the offer, may verify terms and conditions of the offer with the client, or otherwise. Post-purchase activities of the client and marketplace server 102 are described in greater detail with reference to FIG. 14. The customer account information may be stored in a user profile. When users receive their search results, the search results may include a number of people of searching the same parameters. The user may select that number which shows a visible profile of each user. The profiles of each user may be in a default private setting. Accordingly, the visible profile may only show the location of the user and a user identification number. Upon entering a user-to-user chat session, the user may provide a user profile command. The user profile command may enable one or more aspects of the user's profile to become visible to the other chat attendees. In another embodiment, the user profile command may be structured to control which aspects are visible and to whom (e.g., although a user is in a group chat session with users A, B, C, and D, a user may only make some aspects of their profile visible to user A and user C, no users B or D). In this manner, as users become more familiar with other users, users may select to permit more details of their profile to become public.

Referring now to FIG. 4B, the activities of vendor account module 318 are shown in greater detail. Vendor account module 318 is configured to manage vendor interaction with marketplace server 102. Vendor account module 318 may include a vendor profile module 420. Vendor profile module 420 may include information relating to the vendor such as the vendor name, products and services offered by the vendor, a vendor interaction history with the marketplace server (e.g., the number of times a vendor has sold an offer to a client or chatted with a client, etc.), and other vendor information. Vendor profile module 420 may be configured to provide vendor information to a client as part of the search results, as part of the chat interface or bidding interface, or otherwise.

Vendor profile 420 may include information about the specific offers provided by the vendor. For example, in one embodiment, the online marketplace system of the present disclosure may allow clients to provide a bid on an offer (e.g., a price). Vendor profile 420 may include information about specific products and services provided, along with any other options. For example, if the vendor sells shoes, vendor profile 420 may include a list of brands of shoes offered, options for the shoes like shoe size and shoe color, and other information. Vendor profile 420 information may then be provided to the client such that the client can provide a specific offer to the vendor.

Vendor account module 318 further includes vendor feedback module 422. Vendor feedback module 422 is configured to track feedback provided by clients for each vendor. After a client provides vendor feedback (see feedback module 320 of FIG. 3), vendor feedback module 422 may store and organize the vendor feedback. The vendor feedback may then be provided to a client in a subsequent search. In various embodiments, the vendor feedback may be provided upon client request, or may be provided as part of the search results.

Vendor account module 318 further includes vendor account information 424. Vendor account information 424 may include vendor information related to the use of marketplace server 102. For example, vendor account information 424 may include vendor preference information such as a preferred preview image, preview image presentation, or vendor description. Vendor account information 424 may be displayed to a client in various ways. For example, vendor account information may be included in the display with a chat interface or bidding interface, so that the client may view the vendor account information without looking away from the chat interface or bidding interface.

Vendor account module 318 further includes vendor subscriptions 426. A vendor may subscribe to marketplace server 102, according to an exemplary embodiment. The vendor subscription may allow the vendor's search results to receive preferential treatment, may allow the vendor a better chance to chat with and provide offers to clients compared to other vendors, etc. For example, if a vendor subscribes to marketplace server 102, the search results related to the vendor may be given priority compared to other search results (the search results may be highlighted or listed at the top of the website, for example).

The vendor subscription to marketplace server 102 may vary, according to various embodiments. In one example, there may be no cost to subscribe to marketplace server 102. In another example, there may be a cost to subscribe to marketplace server 102, and different costs of subscriptions may affect the level to which the vendor is given preferential treatment compared to other vendors.

Vendor account module 318 may further be configured to manage post-purchase activities. For example, upon the vendor selling an offer, vendor account module 318 may be configured to hold client funds in escrow for the vendor, may authorize the vendor for selling of the offer, may verify terms and conditions of the offer with the vendor, or otherwise. Post-purchase activities of the vendor and marketplace server 102 are described in greater detail with reference to FIG. 14.

Referring again to FIG. 3, memory 308 further includes feedback module 320. Feedback module 320 may manage client feedback provided by the client about the vendors. For example, upon completing interaction with a vendor (e.g., by either chatting with the vendor, purchasing an offer from the vendor, or otherwise interacting with the vendor in a bidding process or chatting process), the client may provide vendor feedback. The vendor feedback may relate to the quality of offers provided by the vendor, the quality of interaction with the vendor (e.g., friendliness), the relevancy of offers provided by the vendor, etc. The vendor feedback may also include if the vendor was previously cited for misusing the chat interface or bidding interface (if the vendor was identified as an offender by a filtering process of interactive chat module 312 or interactive bidding module 314). Feedback module 320 may receive and store the feedback. The feedback may be provided by the client by providing comments or by rating the vendors based on a numerical value or rating system.

Further, feedback module 320 may generate a vendor profile based on the feedback. The vendor profile may indicate to a client how friendly the vendor is, how often an offer is purchased from the vendor, the types of offers provided by the vendors, etc. Feedback module 320 may then provide the vendor profile to a client upon request, or may provide the vendor profile along with the search result relating to the vendor.

Referring generally to FIGS. 5-8, exemplary graphical user interfaces for the online marketplace system are shown, according to an exemplary embodiment. Referring more specifically to FIG. 5, a graphical user interface 500 for displaying search results is shown. In user interface 500 of FIG. 5, search results are shown to the client as a result of a search request from the client. The search results may be sorted by relevancy to the client as described above. In various embodiments, the search results may be sorted by search engine (e.g., search results found by the same search engine are grouped together), search results related to vendors subscribed to the marketplace server may be displayed at the top of the page, etc. For example, in FIG. 5, search results may first be sorted by the search engine that generated the search result (e.g., Bing, Yahoo, Google, etc.), and then by relevancy to the client or by vendor subscriptions to the online marketplace system. The search results may be repeated for each search engine (e.g., a search result retrieved by both Bing and Yahoo may be displayed once under each search engine) or the duplicate search results may be removed for one of the search engines.

An example search result 502 created by the online marketplace system of the present disclosure may include a description 504 for the search result. Description 504 may include a title, a small preview window, and general information about the search result. In addition, various links or buttons may be provided on user interface 500 to allow the client to interact with the marketplace server. For example, search result 502 includes a preview link 506. Upon selecting preview link 506, one or more preview images 508 for the website are displayed to the client as described with reference to website preview module 402.

Search result 502 further includes a chat link 510. Upon selecting chat link 510, a chat interface may be provided to the client and to a vendor. The chat interface is shown in greater detail in FIG. 6. The chat interface may be provided as a window on the current webpage, or the client may be taken to a new webpage. For example, upon selecting chat link 510, an alert may be provided to the corresponding vendor, and a chat window may be opened on the current webpage upon vendor acceptance. As another example, upon selecting chat link 510, the chat window may be provided instantly to the client, and the vendor may enter or exit the chat window at any time. As a further example, chat link 510 may provide access to a user chat option (see FIG. 15).

Search result 502 may optionally further include a bid link 512. Upon selecting bid link 512, a bidding interface may be provided to the client. The bidding interface is shown in greater detail in FIG. 7. The bidding interface may be selected by link 512 or may be selected from the chatting interface window, according to various embodiments. For example, the bidding interface may be activated from the chat interface, and link 512 may not be provided, in one embodiment.

User interface 500 may include one or more buttons, such as a checkbox 514, allowing the client to select one or more search results and vendors. This may allow the client to select multiple vendors to chat with or to start a bidding process with. For example, a client may select multiple search results via checkbox 514, then select a chat link 510 or another link or button on user interface 500 to open a chat interface that multiple vendors are invited to.

Referring to FIG. 6, the chat interface system is shown in greater detail. In the user interface 600 of FIG. 6, the client has selected a vendor to chat with. While user interface 600 illustrates a client chatting with one vendor, in other embodiments, the client may chat with more than one vendor (e.g., by chatting with multiple vendors in the same chat window or by opening one chat window for each vendor). In the embodiment of FIG. 6, chat interface 602 is shown as loaded on the same website as the search result; in other embodiments, another website may be used to display the chat interface. While chat interface 602 is shown as a new window on the same website, it should be understood that chat interface 602 may be any type of window or interface as described with reference to interactive chat module 312 of FIG. 3. For example, chat interface 602 may be embedded on the right or left side of user interface 600, chat interface 602 may be opened directly above, below, or next to the corresponding search result, chat interface 602 may only pop up on user interface 600 in any location once the vendor sends a message, etc.

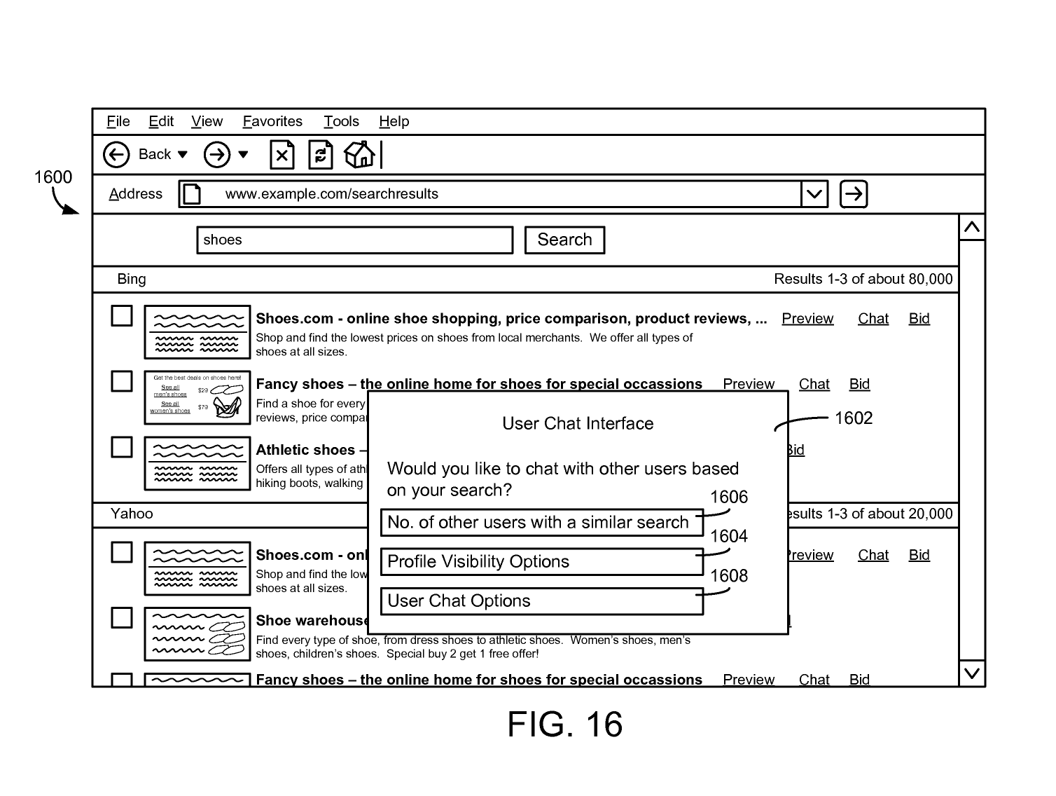

In chat interface 602, a conversation is shown between a client and the vendor. The client may ask for information related to products and services offered by the vendor. Chat interface 602 may display the conversation. Chat interface 602 may further include one or more buttons that allow the client to initiate a bidding sequence (e.g., button 604 for asking the vendor to provide an offer) or to view vendor information or a vendor website (e.g., button 606). FIG. 6 shows a chat interface based on a client-to-vendor interaction. In comparison, FIG. 16 shows a chat interface for client-to-client interaction (e.g., user-to-user).

Referring to FIG. 7, the bidding interface system is shown in greater detail. In the user interface 700 of FIG. 7, the client has selected to initiate a bidding process with one or more vendors. Bidding interface 702 is then provided to the client and all vendors the client wishes to include in the bidding process.

The client may start the bidding process, and vendors may provide offers to the client. The client may choose to accept or reject an offer. In one embodiment, links 704, 706 may be provided to the client in bidding interface 702 to accept and reject offers. In other embodiments, other buttons or links may be provided on the screen or bidding interface 702 to allow the client to accept or reject an offer. In yet other embodiments, the client may not be able to accept or reject offers, but may be able to talk to the vendors and select a vendor to chat with using chat interface 602. Upon selecting an offer to purchase from a vendor, the client may be taken to a website of the vendor or another website to complete the transaction.

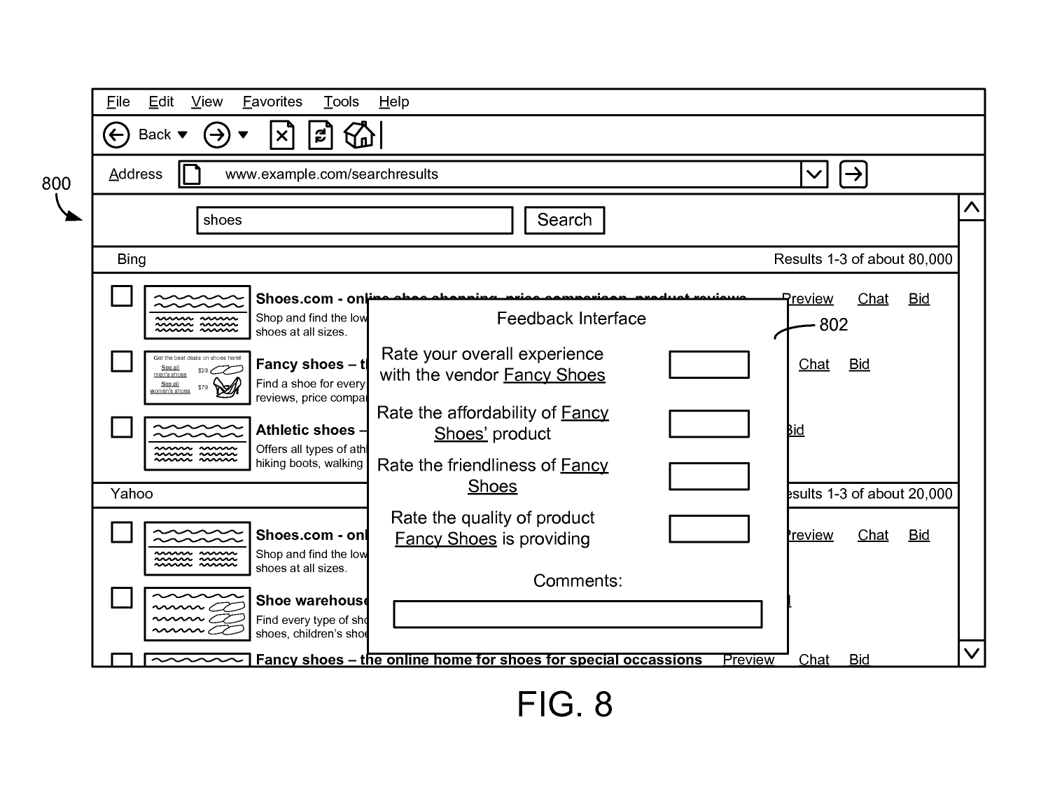

Referring to FIG. 8, the feedback system is shown in greater detail. Using user interface 800 of FIG. 8, the client may leave feedback related to the one or more vendors the client has interacted with (either via the chat interface or the bidding interface). Feedback interface 802 is provided to allow the client to provide feedback. Feedback interface 802 may be provided in a new window on the same webpage as the search results, or a new webpage may be loaded for the feedback interface.

Feedback interface 802 may allow the client to rate a vendor or product. The client may rate an overall experience with the vendor during the chatting and bidding process, may rate the quality and affordability of the products offered by the vendor, or may rate any other interaction with the vendor. Further, the client may leave comments about the vendor. Feedback interface 802 may receive the client input and provide the input to feedback module 320.

Using the feedback provided via feedback interface 802, the online marketplace system may be configured to allow a client to view the vendor feedback. For example, a link may be provided with search results for a vendor that when selected, allows the client to view vendor feedback (e.g., the vendor's rating, and selected comments about the vendor).

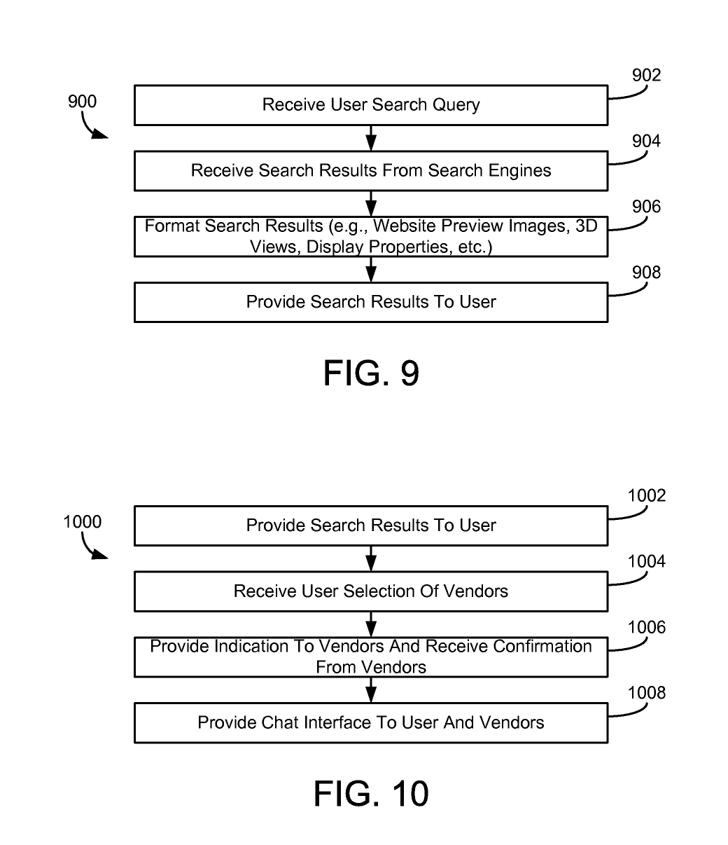

Referring now to FIG. 9, a flow chart of a process 900 for providing search results to a user of the online marketplace system is shown, according to an exemplary embodiment. Process 900 may be executed by, for example, a search engine module 310 of a marketplace server 102. Process 900 may be executed to provide search results to the user, allowing the user to select vendors associated with the search results for participation in a chat interface or bidding interface.

Process 900 includes receiving a user search query (step 902) and receiving the search results from search engines (step 904) related to the search query. The search results may then be formatted (step 906). The formatting of the search results may include generating website preview images, 3D views of the websites of the search results, determining display properties associated with the search results, reordering the search results based on vendor subscriptions and other information, and any other step as described with references to modules 402-408 of search engine module 310. Step 906 may further include providing a chat link or bid link with each search result, allowing the user to select a vendor to chat with or invite to a bidding process. The formatted search results are then provided to the user (step 908).

Referring now to FIG. 10, a flow chart of a process 1000 for providing a chat interface to a user and vendors of the online marketplace system is shown, according to an exemplary embodiment. Process 1000 may be executed by, for example, an interactive chat module 312 of a marketplace server 102.

Process 1000 includes providing search results to the user (step 1002). Process 1000 further includes receiving a user selection of one or more vendors (step 1004). The user may select vendors by clicking a link associated with a particular search result, by clicking on one or more checkboxes to select multiple vendors, etc. Process 1000 further includes providing an indication to the selected vendors and receiving confirmation from the vendors (step 1006). Step 1006 may generally entail alerting the vendors to user interest and receiving confirmation of vendor participation for chatting with the user. Process 1000 further includes providing the chat interface to the user and the selected vendors (step 1008). The user and vendor may then chat with each other using the chat interface. While in some embodiments or situations process 1000 may operate between a single client and vendor, in other embodiments or situations process 1000 may allow one or more clients access to the chat interface to chat with one or more vendors at the same time.

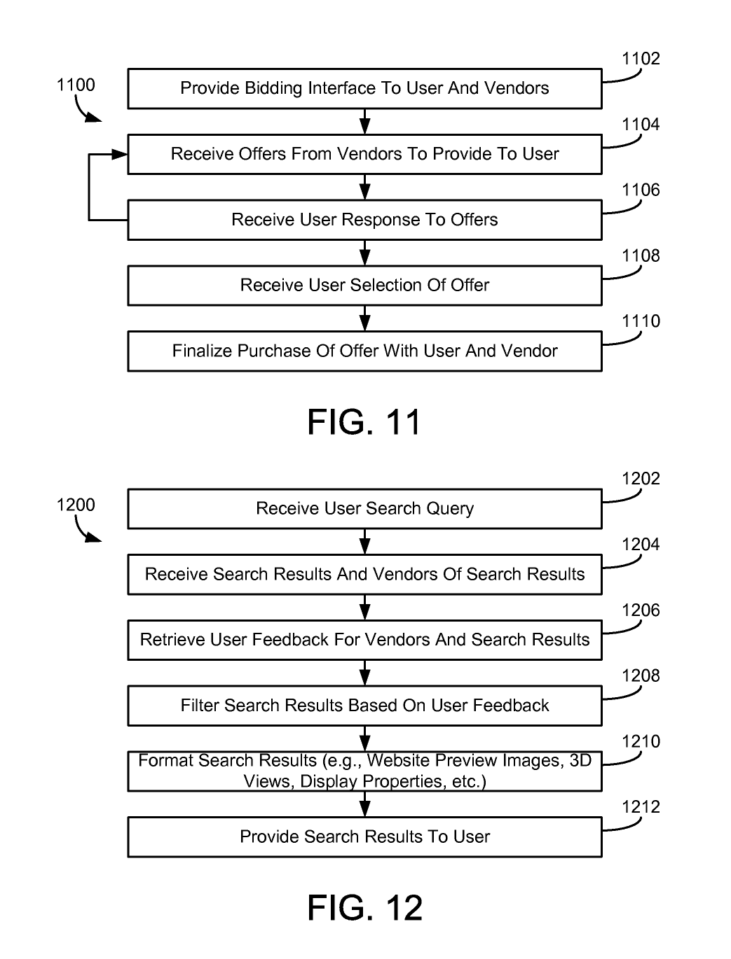

Referring now to FIG. 11, a flow chart of a process 1100 for providing a bidding interface to a user and vendors of the online marketplace system is shown, according to an exemplary embodiment. Process 1100 may be executed by, for example, an interactive bidding module 314 of a marketplace server 102.

Process 1100 includes providing a bidding interface to the user and vendors (step 1102). The bidding interface may be provided upon user request, according to one embodiment. The bidding interface is provided to the vendors that the user has selected. Process 1100 further includes receiving offers from the vendors to provide to the user (step 1104). Step 1104 may further include receiving other terms and comments related to the offers.

The user may receive the offers and may provide a response to the offers (step 1106). The response may be or include a rejection of an offer, an acceptance of an offer, or comments directed to the offers and/or vendors. If the user rejects the offers, the vendors may provide another offer or other comments to the user (step 1104).

When the user accepts an offer (step 1108), process 1100 further includes finalizing a purchase of the offer with the user and vendor (step 1110). Step 1110 may include verification of the purchase, or may simply include providing the user and vendor with an interface or another method of contact to complete the transaction. For example, after the user accepts an offer, the user and vendor may finalize the purchase independent of the marketplace server or using an interface of the marketplace server.

Referring now to FIG. 12, a flow chart of a process 1200 for providing search results to a user of the online marketplace system is shown, according to an exemplary embodiment. Process 1200 may include using user feedback to provide the search results. Process 1200 may be executed by, for example, a search engine module 310 and feedback module 320 of a marketplace server 102.

Process 1200 includes receiving a user search query (step 1202) and receiving search results and the vendors of the search results (step 1204). Process 1200 further includes retrieving user feedback for the vendors and search results (step 1206). User feedback may relate to the specific search result or the vendor.

Process 1200 further includes filtering the search results based on the user feedback (step 1208). For example, the search results and vendors associated with the search results with the best feedback may be presented at the top of the search results, while the search results and vendors associated with the search results with the worst feedback may be presented at the bottom of the search results or may not be presented at all.

Process 1200 further includes formatting the search results (step 1210) and providing the search results to the user (step 1212). Steps 1210-1212 may be similar to steps 906-908 of process 900 of FIG. 9.

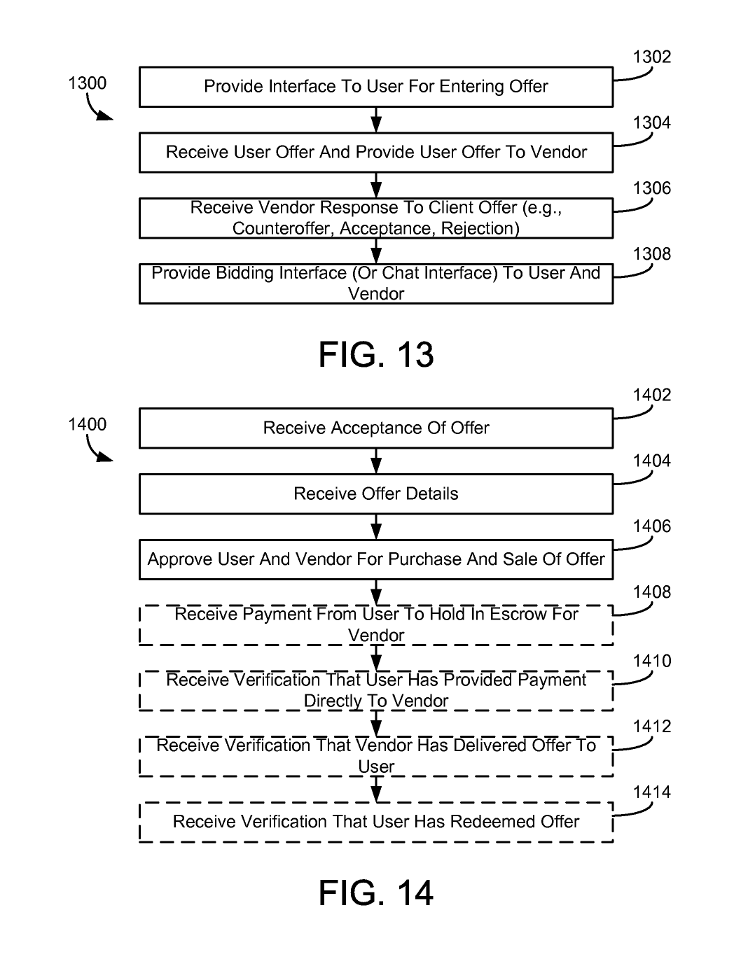

Referring now to FIG. 13, a flow chart of a process 1300 for providing a bidding interface in response to a user offer to a user and vendors of the online marketplace system is shown, according to an exemplary embodiment. Process 1300 may be executed to allow a user of the online marketplace system to select or bid on an offer for a product or service, and the vendor can respond to the user instead of the other way around.

Process 1300 includes providing an interface to the user for entering an offer (step 1302). For example, step 1302 may include providing a chat interface or bidding interface as described in the present disclosure, and the user may simply type in the offer. As another example, step 1304 may include providing an interface to the user that allows the user to select one or more vendor offers or one or more options related to the offers. For example, a list of offers may be provided to the user, and the user may select an offer and enter a bid for the offer. Further, options for the offer (e.g., for shoes, the shoe color may be an example of an option) may be selected by the user. The interface may be provided as part of a chat interface or bidding interface or as part of the search result (e.g., upon selection of a link of the search result, the offers and options may be chosen).

Process 1300 further includes receiving the user offer and providing the user offer to the vendor (step 1304). Process 1300 further includes receiving a vendor response to the client offer (step 1306). The vendor response may be an acceptance of the offer, a rejection of the offer, a counter-offer, or any other comment or reaction to the offer. Process 1300 further includes providing a bidding interface (or a chat interface) to the user and vendor (step 1308). The interface may allow the user and vendor to negotiate on the offer, finalize an acceptance or rejection of the offer, or to otherwise discuss the offer.

Referring now to FIG. 14, a flow chart of a process 1400 for offer authorization of the online marketplace system is shown, according to an exemplary embodiment. Process 1400 may be executed by the online marketplace system upon receiving an indication that a client and vendor have reached an agreement on an offer. Process 1400 may be used to authorize the purchase of the offer by the client and to otherwise manage the process of providing the payment to the vendor and the offer to the client.

Process 1400 includes receiving an acceptance of an offer (step 1402). The acceptance of the offer may be submitted through, for example, the bidding interface. Upon acceptance of the offer, the marketplace server may receive the offer details (step 1404). The offer details may include the product or service being sold, the price of the offer, a payment method for the offer, a delivery method for the offer (e.g., how the offer is to be redeemed or sent to the user), terms of the offer (e.g., refund details, offer insurance, or other terms or conditions for the usage of the services of the offer), and other offer information.

Process 1400 further includes approving the user and vendor for the purchase and sale of the offer (step 1406). Step 1406 may include verifying that the user has the funds available to purchase the offer. For example, the user may provide payment information to the marketplace server, and the marketplace server may approve the user. The marketplace server may process the payment itself or may simply verify the payment method and let the vendor handle the payment processing. In another embodiment, the marketplace server may open an escrow account for the user and hold the user funds, and then release the funds to the vendor at an appropriate time (e.g., upon delivery of the offer to the user). Step 1406 may further include verifying that the vendor has an available offer to provide to the user. For example, using vendor information from a vendor account module (e.g., module 318 of FIG. 4B), the marketplace server may verify that the vendor is able to provide the offer. Step 1406 may further include any verification process associated with any of the terms of the offer.

Process 1400 may further include various optional steps for authorizing the offer purchase upon user and vendor approval. For example, process 1400 may include receiving payment from the user to hold in escrow for the vendor (step 1408). As another example, process 1400 may include receiving verification that the user has provided payment directly to the vendor (step 1410). As yet another example, process 1400 may include receiving verification that the vendor has delivered the offer to the user (step 1412). As yet another example, process 1400 may include receiving verification that a user has redeemed an offer (step 1414). Any of the information received in steps 1108-1114 may be used by the marketplace server to verify that the offer purchase was completed without a problem to either the user or vendor. Process 1400 may further include determining if any of the verification steps that should have occurred have yet to occur, and if a message or warning should be provided to either the user or vendor about the missing verification steps. For example, if a user missed a payment, if the vendor did not provide the offer within a given time frame, or if the user or vendor violated a term or condition of the offer, the user and/or vendor may be notified.

Referring now to FIG. 15, a flow chart of a process 1500 for providing a user chat interface is shown, according to an exemplary embodiment. Process 1500 may be executed by, for example, an interactive chat module 312 of a marketplace server 102. In some embodiments, operations of process 1500 may be split between marketplace server 102 and search engine 104.

Process 1500 includes receiving a search query for a user (step 1502). This user may be referred to as the initiating user. The search may use hashtags and any other type of search methods/protocol. Process 1500 further includes determining a number of other users searching a substantially similar search query as the search query for the initiating user (step 1504). Similarity may be based on matching algorithms, formulas, or other processes designed to match the initiating user's search query with the search queries of other users. For example, similarity may be based on the use of nouns (e.g., User A may search “how do I recharge a battery?” User B may search “battery-powered vehicles.” User C may search “flashlight batteries.” Because users B and C searched the noun “battery,” they may be determined to have a similar search parameter as user A). The matching determinations may be structured in a variety of ways, with only one example described above. Accordingly, this example is not meant to be limiting. Search results are provided based on the search query from the initiating user (step 1506). The search results may be provided in accord with step 904 of process 900.

An indication of the number of other users may be provided to the initiating user along with the search results (step 1508). The indication may appear on a graphical user interface. This graphical user interface may appear in another window relative to the search results, in a shared window with the search results, as a pop-up, as link, etc. The provided indication may be based on the users that are currently on-line, the number of other users that performed the similar search in the past X timeframe (e.g., three days), and any other feature. Using the above example, if the indication is based on the users currently on-line and users B and C are off-line, they may be excluded from the indication. In another example, if one or more of the other users are off-line (e.g., based on a timeframe parameter), a chat session may be provided to them next time they go online. This chat session may be a pop-up or an email and may be configured to allow the exchange of information with an initiating user.

A user chat option may be provided also on the graphical user interface (step 1510). The user chat option may be provided after the initiating user selects the indication of the number of users searching the same or substantially the same query. Accordingly, if no other users are searching this query (e.g., based on the parameter that the user only wants to chat with users currently on-line), a user chat option may not be provided. However, if there are other users searching substantially similar parameters, the initiating user may be provided with user chat options (step 1510). For example, ten other users may be shown to be also searching this parameter. The user may select the number ten, which takes them to another window with a list of the ten specific users. Included in the list may be the user chat options.

The user chat option may be location-based. For example, an initiating user may choose to chat only with other users in their location or in a location they select (e.g., the physical vendor location may be in a neighboring state and they may wish to interact with people in that state who frequent that location). The user chat option may be peer-to-peer. In turn, the initiating user only chats with one other user. In one embodiment, the initiating user may select which user to initiate a chat session with from a list of users provided in the indication (e.g., step 1508). The user chat option may be group-based. For example, the initiating user may select more than other users in the list of users to initiate a chat session with.

At step 1512, a response to the user chat option is received from the initiating user. The response includes which user chat option to utilize and with which other users. In some embodiments, a default user chat option may be selected, such that it automatically sets the user chat option with no response needed.

At step 1514, a user chat interface is generated. In one embodiment, the user chat interface is configured as a chat session that appears on the initiating user's graphical user interface and other graphical user interfaces of other users included with the user chat. The chat session may be provided alongside the search results, in a window separate from the search results, via a link, a pop-up, etc.

Process 1500 further includes receiving a user profile command (step 1516). As mentioned above, the user profile command is structured to adjust the visibility of a user's profile. The visibility settings may be different based on if the user is entering a chat session and the list of users included in the number of users searching the same or substantially the same query. For example, the visibility may be limited to a user location and a user identification number in the list. In this example, the initiating user may observe where other users are located and select the users they wish to chat with based on their location. Upon entering a chat session, the visibility may further include past search requests by the user. However, controlling what aspects of a user profile are visible, to whom, and when may be controlled via the user profile command of step 1516.

The user profile command may also include activating/deactivating the user chat feature. For example, user A may be the only other user searching the same parameters, however, user A has deactivated the user chat feature. Accordingly, the initiating user will receive an indication of zero other users.

Referring now to FIG. 16, an example graphical user interface for providing a user chat interface is shown, according to an exemplary embodiment. User chat interface 1602 is shown as loaded on the same website as the search result; in other embodiments, another website may be used to display the user chat interface. While user chat interface 1602 is shown as a new window on the same website, it should be understood that user chat interface 1602 may be any type of window or interface as described with reference to interactive chat module 312 of FIG. 3. For example, user chat interface 1602 may be embedded on the right or left side of user interface 1600, user chat interface 1602 may be opened directly above, below, or next to the corresponding search result, user chat interface 1602 may only pop up on user interface 1600 in any location once the vendor sends a message, etc.

User chat interface 1602 provides a user profile visibility options module 1604 (e.g., step 1516); an indication of a number of other users with a similar search module 1606 (e.g., step 1508); and user chat options module 1608 (e.g., step 1510). Although the user chat options module 1608 is shown as separate from the number of other users with a similar search module 1604, the user chat options may be a separate window or pop-up that is accessible when there are other users.

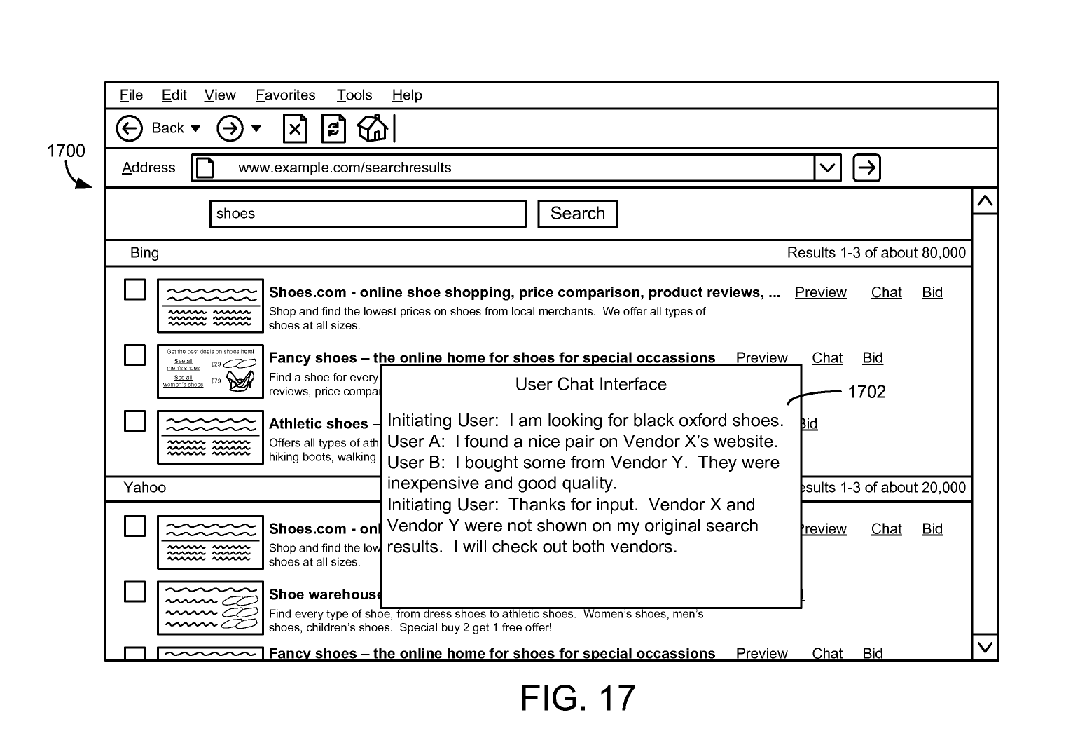

In one example, the initiating user may select a user chat option, such that a user chat session is generated and shown in FIG. 17. The user interface 1700 is shown to include user chat session 1702. As shown, the users—who had a similar search for “shoes”—are able to converse. In this example, the initiating user informs the other users that vendors X and Y were not included in their provided search results. However, after going to those vendors websites, marketplace server 102 may update the list of search results based on this and other site traffic. In this event, sites that are most frequented will be presented sooner in the list of search results.

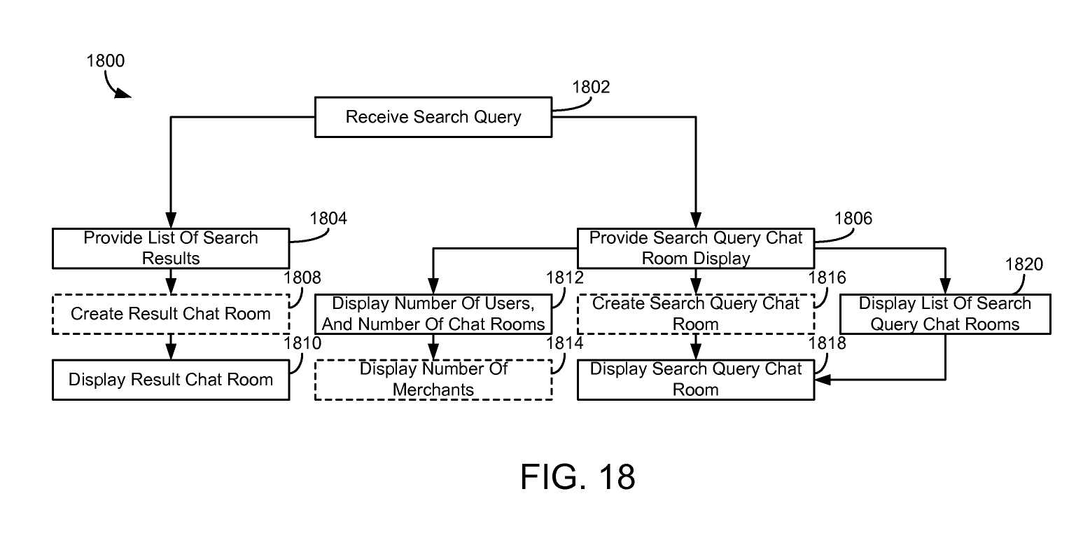

Referring now to FIG. 18, a flow chart of a process 1800 for displaying search results and providing chat options for users of the online marketplace system is shown, according to an exemplary embodiment. In embodiments, process 1800 includes receiving a search query for a user (1802). In embodiments, process 1800 includes providing to a graphical user interface (GUI) a list of search results based on the search query, wherein each search result of the list of search results comprises a link and a result chat icon (1804). In embodiments, when the result chat icon associated with a search result of the list of search results is selected and no result chat room associated with the search result exists, process 1800 includes creating (1808) and displaying (1810) a result chat room associated with the search result. In embodiments, when the result chat icon associated with a search result of the list of search results is selected and the result chat room associated with the search result exists, process 1800 includes displaying the result chat room associated with the search result (1810).

Still referring to FIG. 18, in embodiments, process 1800 includes providing to the GUI a search query chat rooms display (1806). In embodiments, the search query chat rooms display comprises a plurality of numbers, wherein a first number of the plurality of numbers indicates a number of other users currently searching a same or substantially same search query and a second number of the plurality of numbers indicates a number of search query chat rooms regarding the search query. In embodiments, process 1800 includes displaying the number of users and number of chat rooms (1812). In embodiments, when the search query is a product or service, a third number of the plurality of numbers indicates a number of merchants offering the product or service and currently available to chat. In embodiments, process 1800 includes displaying the number of merchants (1814).

Still referring to FIG. 18, in embodiments, the search query chat rooms display comprises a new search query chat room trigger, wherein when the new search query chat room trigger is activated by the user, process 1800 includes creating (1816) and displaying (1818) a new search query chat room.

Still referring to FIG. 18, in embodiments, the search query chat rooms display comprises a list of search query chat rooms regarding the search query. In embodiments, process 1800 displays the list of search query chat rooms (1820). In embodiments, when a search query chat room from the list of search query chat rooms regarding the search query is selected, process 1800 includes displaying the selected search query chat room (1818).

In some embodiments, process 1800 includes displaying simultaneously a plurality of result chat rooms and/or a plurality of search query chat rooms without requiring the user to browse away from the list of search results. In some embodiments, a chat room is not limited to text, but may allow multimedia and display images and videos directly in the chat room. In some embodiments, the user may filter messages in a chat room.

In some embodiments, process 1800 includes storing user account of the user, wherein a user account comprises a real name of a user, a user name, user bookmarks, user history, user chats, user tags, user products, and user friends. In some embodiments, process 1800 includes associating a rating with a search result and storing the rating of the search result, wherein the rating of the search result is based at least in part on votes by users signed in to their user accounts. In some embodiments, process 1800 includes assigning, after verifying identity of the user, the user as owner of a chat room, when the user is signed in to the user account, wherein a user may own a plurality of chat rooms, wherein a chat room may be a result chat room or a search query chat room. In some embodiments, verifying user identification may be accomplished by checking the Social Security Number of the user. In some embodiments, process 1800 includes setting, based on selections of the user, security and privacy settings for a chat room the user owns. In some embodiments, process 1800 includes inviting or removing, based on selections of the user, other users by user name or IP address to or from a chat room the user owns. In some embodiments, user bookmarks may be bookmarks for webpages or chat rooms. In some embodiments, user history may be a record of user activity. In some embodiments, user chats may be chat rooms the user owns or has participated in. In some embodiments, users tags may be used specify a chat room, so that users may find the chat room by searching for the user tag. In some embodiments, user products may indicate products or services the user has purchased through an online marketplace system. In some embodiments, user friends may indicate a list of users the user has saved.

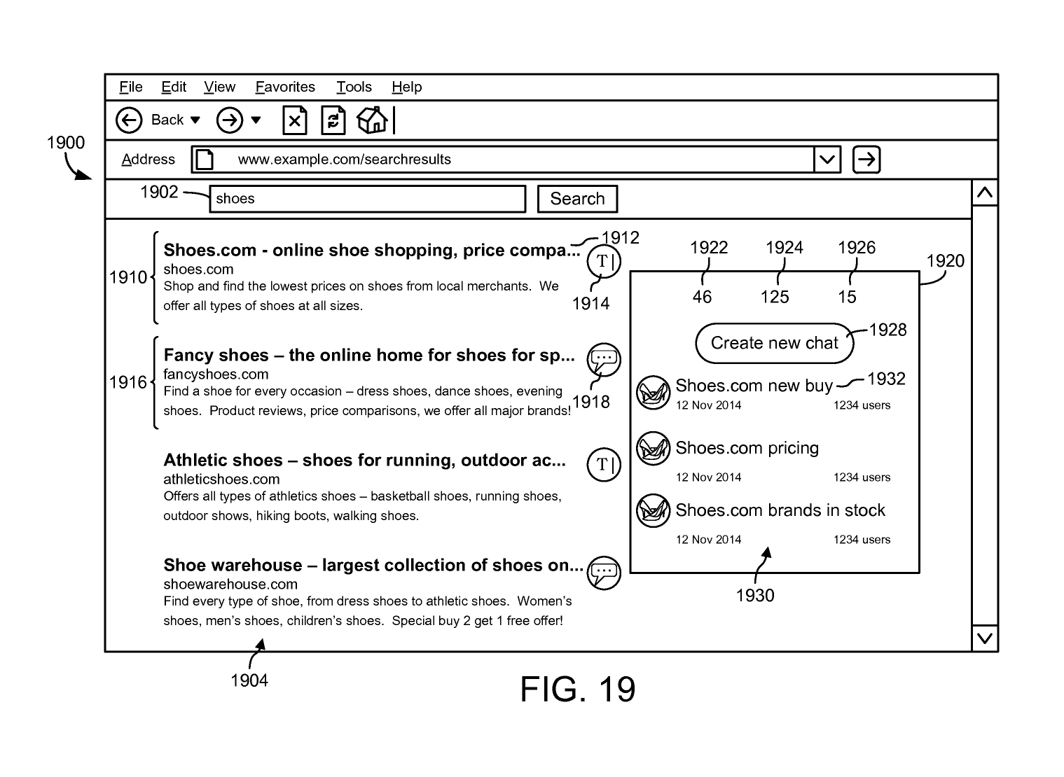

Referring now to FIG. 19, graphical user interface (GUI) 1900 displaying search results and chat options for users of the online marketplace system is shown, according to an exemplary embodiment. In embodiments, GUI 1900 displays the search query 1902. For instance, the search query may be “shoes.” In embodiments, GUI 1900 displays a list 1904 of search results. In embodiments, search result 1910 comprises a link 1912 and a result chat icon 1914. A user may click on link 1912 and proceed to a linked webpage. A user may also start or join a chat about a search result. In embodiments, when no result chat room is associated with a search result, the result chat icon may differ from when a result chat room is associated with the search result. For instance, result chat icon 1914 of search result 1910 may indicate no result chat room is associated with search result 1910. In embodiments, a user clicking on result chat icon 1914 would create and join a result chat room associated with search result 1910, and GUI 1900 would display the (newly created) result chat room associated with search result 1910. Further, result chat icon 1918 of search result 1916 may indicate a result chat room is associated with search result 1916. In embodiments, a user clicking on result chat icon 1918 would join the result chat room associated with search result 1916, and GUI 1900 would display the result chat room associated with search result 1910. Having separate result chat rooms for each search result allows for independent discussion of each search result. In some embodiments, a user may vote on a search result, affecting a rating of the search result.

Still referring to FIG. 19, in embodiments, GUI 1900 displays search query chat rooms display 1920. In embodiments, search query chat rooms display 1920 comprises a plurality of numbers. In embodiments, first number 1922 of the plurality of numbers indicates a number of online users currently searching for a same or substantially same search query. For instance, first number 1922 may indicate the number of other users searching for shoes. In embodiments, second number 1924 of the plurality of numbers indicates the number of search query chat rooms regarding the search query. For instance, second number 1924 may indicate the number of search query chat rooms regarding shoes. In embodiments, when the search query is a product or service, third number 1926 of the plurality of numbers indicates a number of merchants offering the product or service and currently available to chat. For instance, third number 1926 indicates the number of merchants selling shoes and available to chat.

Still referring to FIG. 19, in embodiments, search query chat rooms display 1920 comprises new search query chat room trigger 1928. In some embodiments, new search query chat room trigger 1928 may be a button. In some embodiments, new search query chat room trigger 1928 may be a text field. In embodiments, a user activating search chat room trigger 1928 would create and join a search query chat room regarding search query 1902, and GUI 1900 would display the (newly created) search query chat room regarding search query 1902. For instance, a user may create and join a chat room regarding shoes. In embodiments, search query chat rooms display 1920 comprises a list 1930 of search query chat rooms regarding the search query 1902. In embodiments, a user clicking on search query chat room 1932 from the list 1930 of search query chat rooms would join search query chat room 1932, and GUI 1900 would display search query chat room 1932.

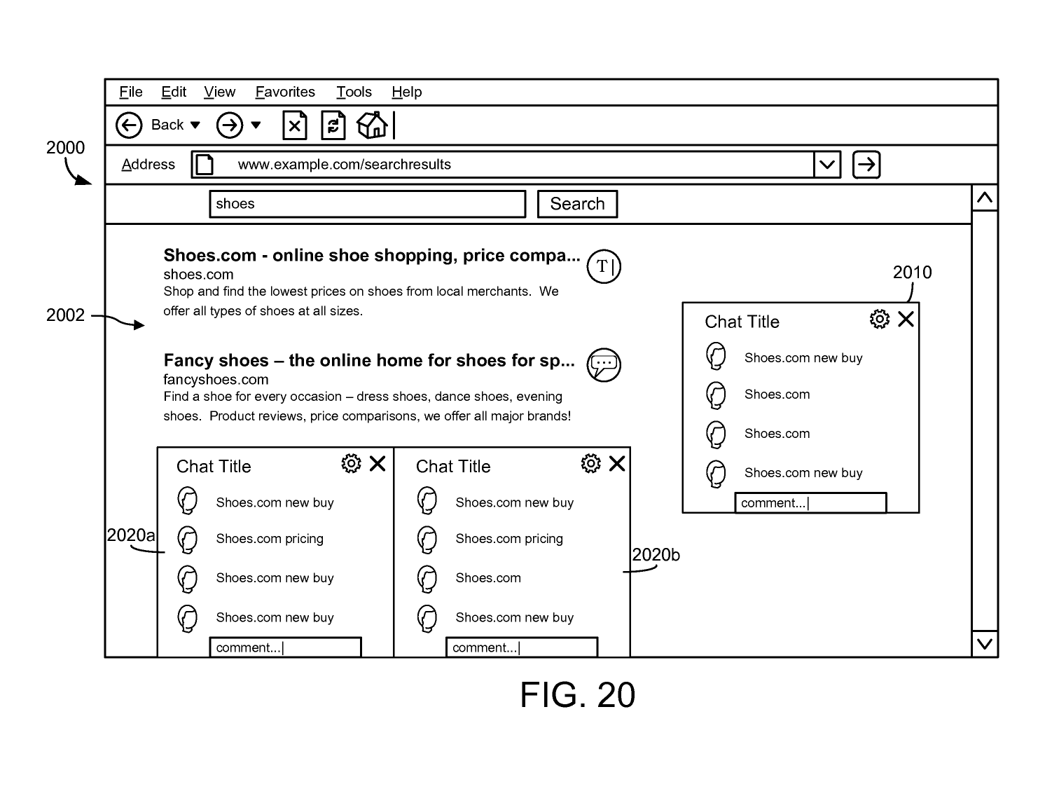

Referring now to FIG. 20, GUI 2000 for displaying chat rooms for users of the online marketplace system is shown, according to an exemplary embodiment. A user may join and participate in a chat room or view chat history. In some embodiments, a chat room is displayed without the user browsing away from the list of search results. For instance, GUI 2000 displays chat room 2010 without the user browsing away from list of search results 2002. In some embodiments, a plurality of chat rooms may be displayed simultaneously. For instance, GUI 2000 displays simultaneously chat room 2010 as well as a plurality of chat rooms 2020. In some embodiments, chat rooms may be docked. For instance, GUI 2000 displays a plurality of chat rooms 2020 docked along the bottom of the display. In some embodiments, a user may see previews of messages from other users in a chat room before the messages are sent. In some embodiments, a preview of a message appears in a lower right corner of the GUI 2000.

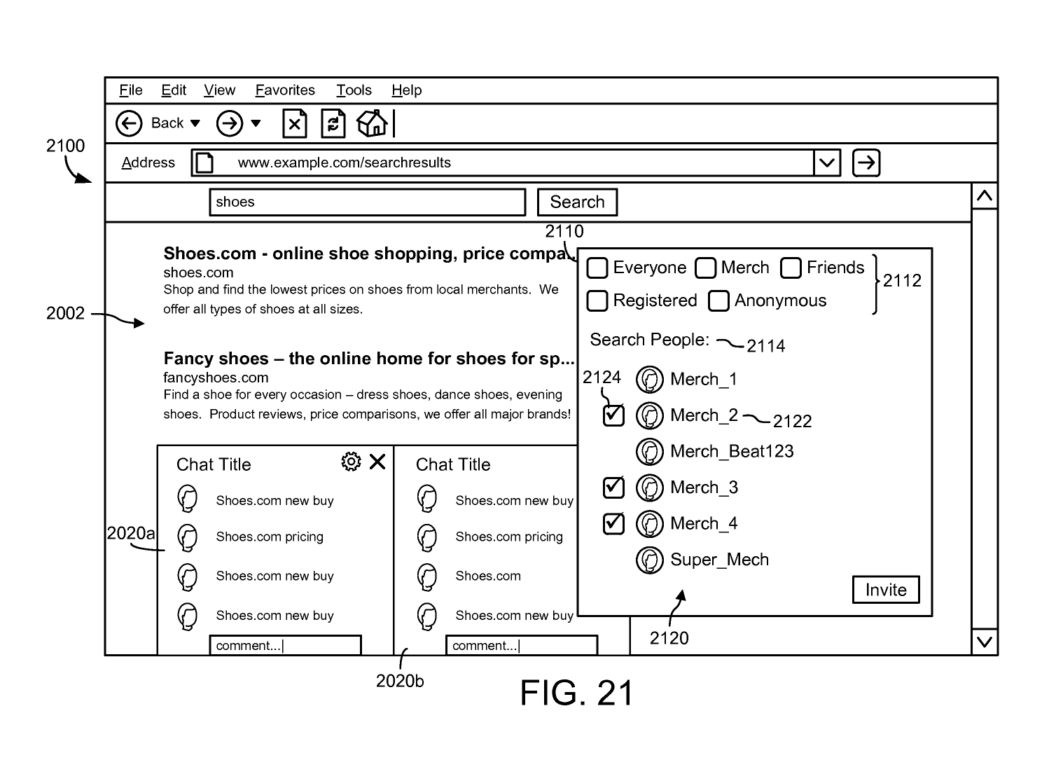

Referring now to FIG. 21, GUI 2100 displays a chat interface for users of the online marketplace system is shown, according to an exemplary embodiment. In some embodiments, a user may set security and privacy settings for a chat room the user owns, including whether the chat room is public or private, or whether users may post anonymously. In some embodiments, a user may own a chat room where the search query is the name of the user. Verification of identify may be done by checking Social Security Number, for instance. In some embodiments, a user may own a chat room where the search query is the name of a product or the name of a company of which the user is the owner. For instance, a user may own a result chat room wherein the link points to the website of a company owned by the user, or a user may own a search query chat room regarding a product sold by the user or by a company owned by the user. Verification of identity would involve checking ownership records, for instance. In some embodiments, the user may invite or remove other users by user name or IP address to or from the chat room the user owns. For instance, invite window 2110 comprises user types 2112, user search field 2114, and user list 2120. In some embodiments, user types 2112 may be used as a filter to select a subset of users to invite to the chat room. In some embodiments, user search field 2114 may be used to search for a user, for instance by name or IP address, and invite that user to the chat room. User list 2120 comprises a list of users that meet the user type filter or user search field. In some embodiments, the user may indicate a desire to invite a user 2122 by selecting check box 2124. The user would click invite to send an invitation to user 2122 to join the chat room. This allows, for instance, the user to create a chat room regarding shoes, set the chat room to private, and invite merchants, to create a bidding or purchasing session.

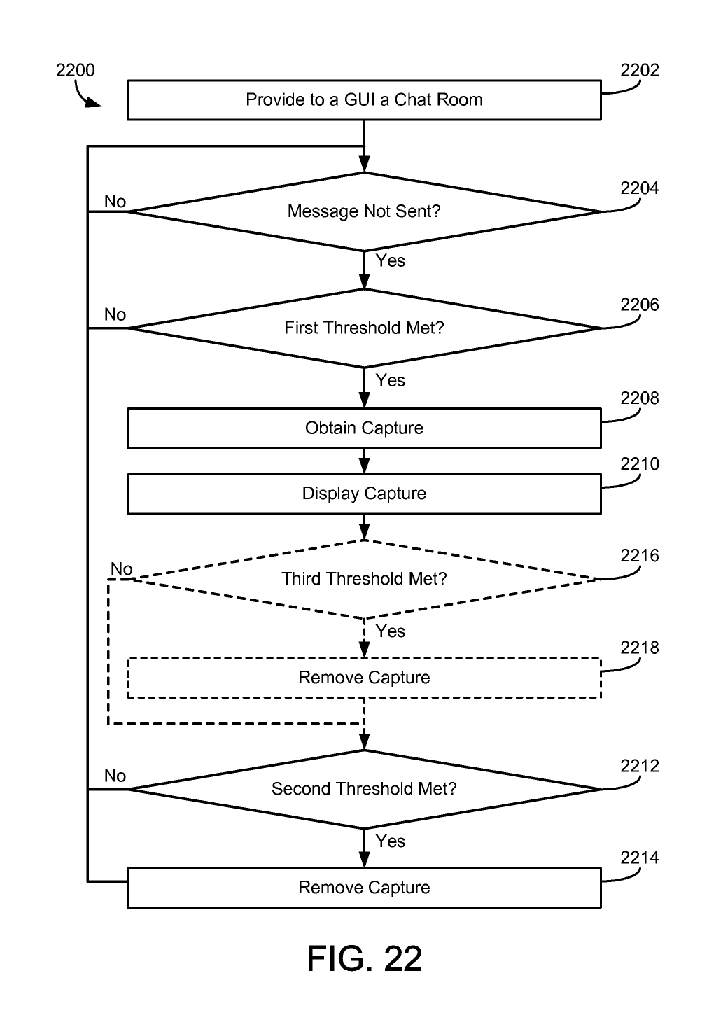

Referring now to FIG. 22, a flow chart of a process 2200 for providing a chat room is shown, according to an exemplary embodiment. In embodiments, process 2200 includes providing to a graphical user interface (GUI) a chat room comprising a plurality of users (2202). In embodiments, while a message of a user of the plurality of the users has not been sent (2204), when a first threshold is met (2206), process 2200 includes obtaining a capture of the message (2208) and displaying in the chat room the capture to other users of the plurality of users (2210). In embodiments, when a number of displayed captures in the chat room is greater than a second threshold (2212), process 2200 includes removing from the chat room an oldest displayed capture (2214). For instance, while a user is typing a message, a sequence of captures of the message being typed is obtained and displayed to the other users, allowing the other users to see the message formation process; the sequence of captures of the message of the user is not displayed in the chat room of the user. When the number of displayed captures exceeds a predetermined number, e.g., ten, process 2200 removes the oldest capture, thus maintaining a display of the ten most recent captures. In embodiments, process 2200 is not limited to one message of one user—when multiple messages of multiple users are being typed, process 2200 would obtain and display, for each user, the ten most recent captures among all of the multiple messages of each other user. For instance, if users A, B, C, and D were in a chat room and all were typing a message, A would see the ten most recent captures of messages by B, C, and D; B would see the ten most recent captures of messages by A, C, and D; C would see the ten most recent captures of messages by A, B, and D; and D would see the ten most recent captures of messages by A, B, and C. In some embodiments, the captures are displayed in a lower right corner of the chat room.

Still referring to process 2200, in some embodiments, the chat room is private. In some embodiments, the first threshold may be a first predetermined number of changes to the message from an immediately-previous capture, or, when no immediately-previous capture exists, from a blank message. For instance, the first threshold may be four changes, and process 2200 would obtain and display a capture whenever the message being typed differs from the immediately-previous capture by four changes. When no immediately-previous capture exists, as when a message is initially begun, the number of changes may be compared to a blank message. In some embodiments, the first threshold may be a first predetermined number of changes to the message from an immediately-previous capture and a first predetermined period of time from the immediately-previous capture, or, when no immediately-previous capture exists, from a blank message. For instance, when the first predetermined number of changes is four, and the first predetermined period of time is 500 milliseconds, when at least four changes to the message being typed have been made, process 2200 does not obtain and display a capture until 500 milliseconds have elapsed since the immediately-previous capture. In another instance, more than 100 milliseconds may have elapsed since the immediately-previous capture, but process 2200 does not obtain and display a capture until four changes to the message have been made.

Still referring to process 2200, in some embodiments, when a number of displayed captures for the message in the chat room is greater than a third threshold (2216), process 2200 includes removing from the chat room an oldest displayed capture of the message (2218), wherein the third threshold may be a second predetermined number of captures to display for a message of each user of the plurality of users. For instance, when the second threshold is ten total displayed captures, and the third threshold is four displayed captures for a message, when users A, B, C, and D are in a chat room and all are typing a message, user A may see, among the ten captures displayed in the chat room of user A, at most the four most recent captures of messages by users B, C, and D, even when the ten most recent captures may be, e.g., all from the message of user C. The four most recent captures of the message of user C would be displayed, as well as the six most recent captures of messages of users B and D, again limited to at most four captures of the message by user B and at most four captures of the message by user D. This prevents the captures of one message from removing all captures of other messages from the display. In some embodiments, the second predetermined number of captures to display for a message of each user of the plurality of users is one.

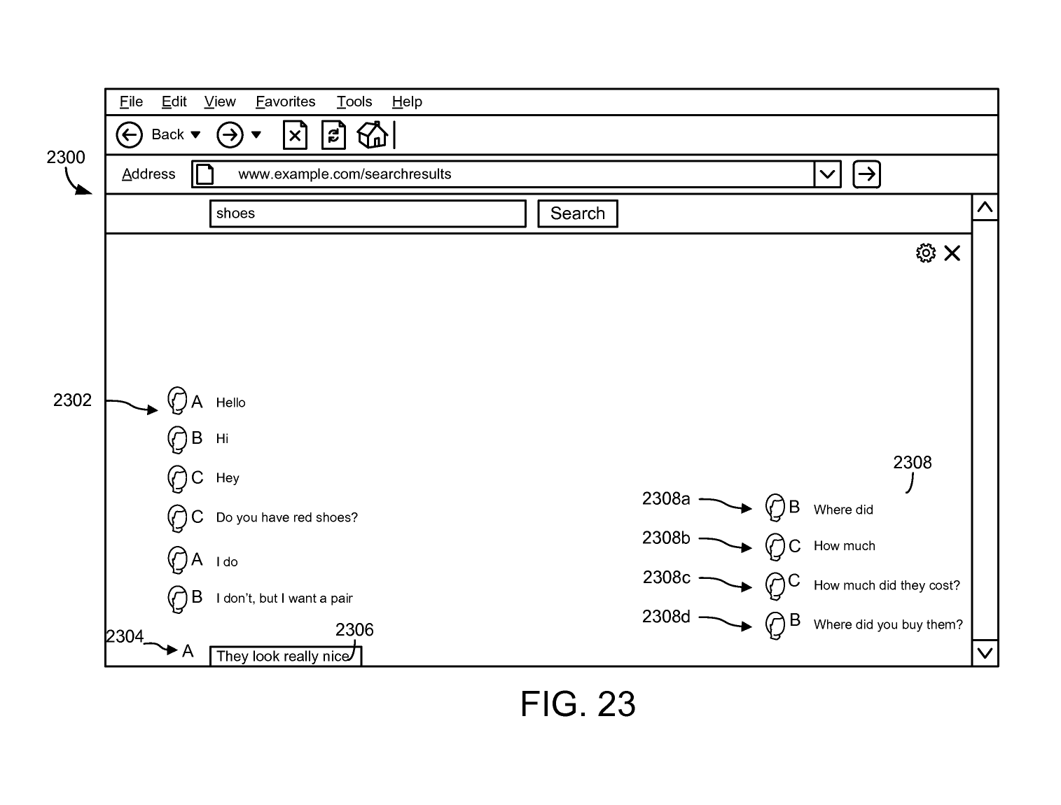

Referring now to FIG. 23 a GUI 2300 displaying a chat room is shown, according to an exemplary embodiment. Old messages 2302 were previously entered, and message input field 2304 allows user A to enter new message 2306. Displayed captures 2308 appear in the lower right corner of the chat room, displayed captures 2308a and 2308d are captures of a message user B is currently typing, and displayed captures 2308b and 2308c are captures of a message user C is currently typing. Messages from users B and C have not been sent, and thus those messages do not show up with old messages 2302. Because the process does not display captures of a message of the user, new message 2306 of user A does not show up in the displayed captures 2308. Embodiments of the process are not limited to chat rooms for an online marketplace system. For instance, a chat room may be an one-on-one conversation between two users using a stand-alone chat application on a computer or mobile device.

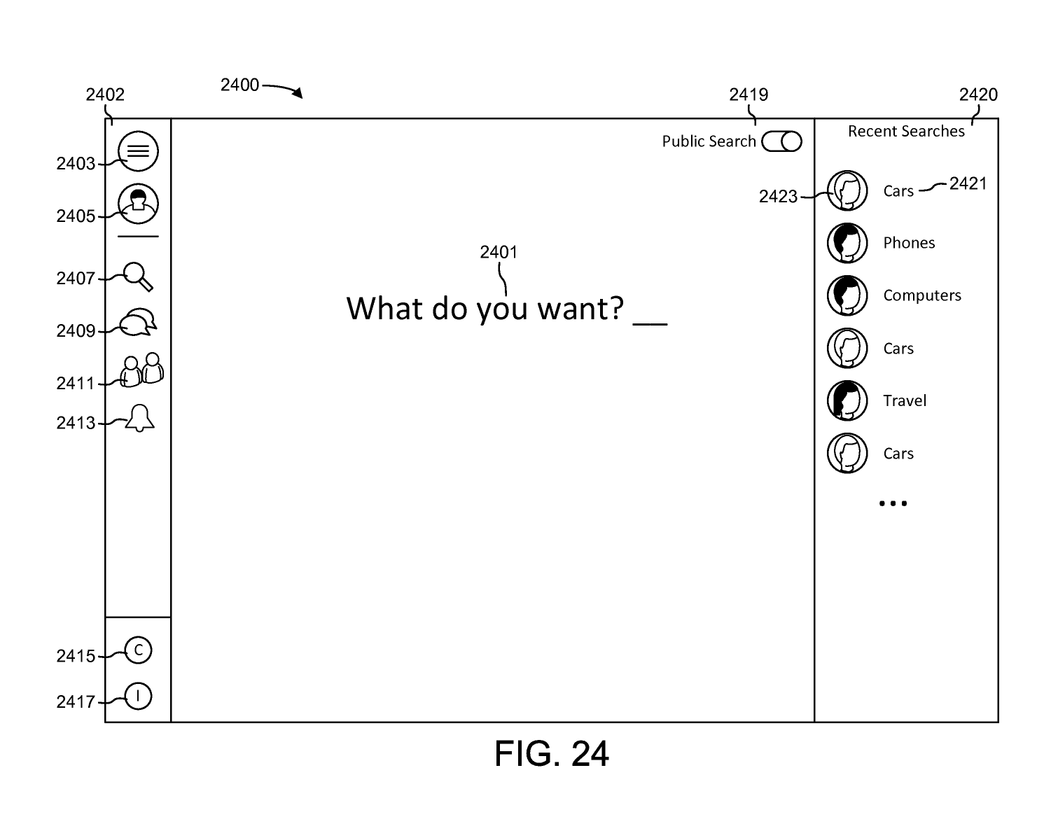

Referring now to FIGS. 24-30, one embodiment of a graphical user interface, and accompanying interaction features, generated by the computer system described herein, is illustrated. The computer system (e.g., marketplace server 102) includes hardware and software components configured to generate the graphical user interface illustrated, according to one embodiment, in FIGS. 24-30. The computer system further handles inputs from clients 106, search engines 104, and/or other remote computing devices (e.g., servers running search engines, computing devices used by users of the graphical user interface and the computer system described herein, and/or other devices). For example, a user may provide a search query, chat initiation request, chat content, and/or other information or requests which are received by network interface 302, processed using processing circuit 304, and acted upon (e.g., an output is provided to the user device). The computer system further provides for outputs to other devices. For example, in response to received requests, instructions, and/or other information received via network interface 302, the computer system may process this information and provide an output via network interface 302 to a client device or other device (e.g., search engine). Output information may be or include instructions and/or information which causes a receiving user device to display one or more elements of the graphical user interface and associated content described herein with reference to FIGS. 24-30.

To provide the graphical user interface described herein to users via user computing devices (e.g., laptop computers, desktop computers, smartphones, and/or other devices), the computer system includes hardware and/or software components configured to perform the functions described herein. The computer system may include one or more components described herein with reference to FIGS. 3A-4B. For example, the computer system (e.g., marketplace server 102) includes network interface 302 and/or other networking hardware to establish communications between the computer system and other devices (e.g., user computing devices running client 106 to access and interact with the computer system via the graphical user interface described with reference to FIGS. 24-30). Network interface 302 may be used to provide instructions for displaying elements of the graphical user interface (e.g., HTML content) and/or information displayed via the graphical user interface (e.g., user specific information such as search results, chat content, profile information, and/or other information). Network interface 302 may also be used to communicate with non-user devices, such as search engines 104. The computer system may transmit received search queries from users to search engines 104 using network interface 302.

The computer system further includes processing circuit 304. Processing circuit 304 is used to process received inputs, retrieve stored information (e.g., user profile information and settings stored in memory 308), and otherwise perform the functions described herein. Processing circuit 304 may use one or more module stored in memory 308 and included in the computer system to perform the functions described herein. For example, processing circuit 304 may use search engine module 310 to receive a user search query, format the request, transmit the request to search engine(s) 104, receive the search results from search engine(s) 104, format the results for display, and generate instructions to be sent to the user device which cause the display of the search results within the graphical user interface as described herein. The computer system may include interactive chat module 312 which is executed by processing circuit 304 to provide for the chat functions described herein (e.g., chat between a user and an additional one or more users). The computer system may include additional modules as described with reference to FIGS. 3-4B.

In some embodiments, the computer system is configured to provide for the purchase of products via the graphical user interface using one or more of the techniques and/or hardware components described herein (e.g., with reference to FIGS. 3, 9-14). In other embodiments, the computer system is not configured to provide for the purchase of products via the graphical user interface. In such embodiments, the graphical user interface described with reference to FIGS. 24-30 does not include features supporting the purchase of products, and the computer system does not include hardware and/or software components used in purchasing products (e.g., interactive bidding module 314, vendor account module 318, and/or other components). The computer system may be configured to provide search results and communication between one or more users. For example, the computer system may include hardware and/or software components configured to provide for chat and/or messaging between users and/or the display of search results as described herein with reference to FIGS. 15-23.

Referring now to FIG. 24, home page 2400 provided by the computer system to a user device is illustrated according to one embodiment. A user may access the computer system using a web browser running on a computing device and/or an application (e.g., running on a smartphone) by causing the browser or application to submit a request to the computer system (e.g., using a universal resource locator, hyperlink, or other transmitted request). The computer system may receive the request using network interface 302, process the request using processing circuit 304 (e.g., to determine user specific information) and serve home page 2400 (e.g., transmit information and/or instructions to the client device using network interface 302 which causes the display of home page 2400). Home page 2400 may include information specific to a user retrieved from memory 308 (e.g., username, user specific settings, search history, chat content, message content, user statistics, and/or other information).

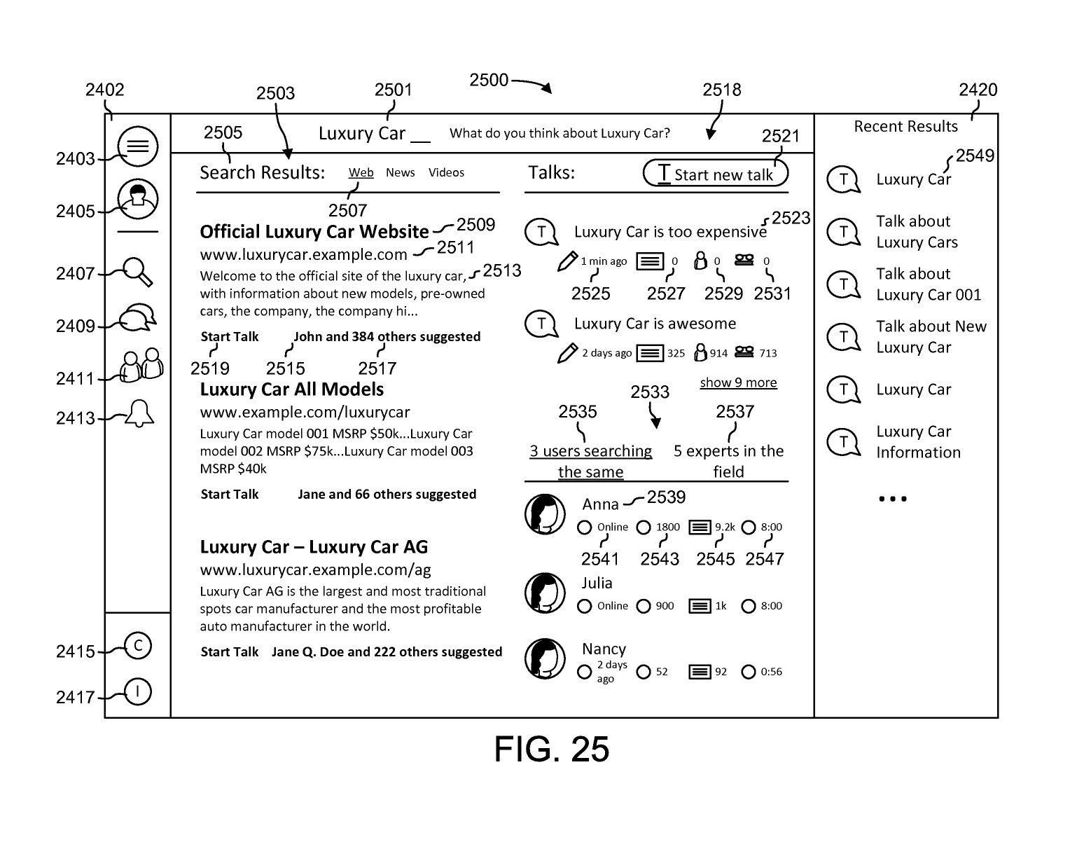

Home page 2400 includes search filed 2401. Search field 2401 is a field of the graphical user interface in which a user may input a search query. Once the user submits the search query (e.g., by pressing enter or a submit button), the search query is transmitted from the user device on which the graphical user interface is displayed to the computer system which receives the search query using network interface 302. The search query is processed, using processing circuit 304 of the computer system, and transmitted to one or more search engines 104. Results from the search engines 104 are receives and processed by processing circuit 304 to format instructions to cause the display of the results on the user device using the graphical user interface. The instructions are then transmitted to the user device using the network interface. The display of search results is described in greater detail with reference to FIG. 25.

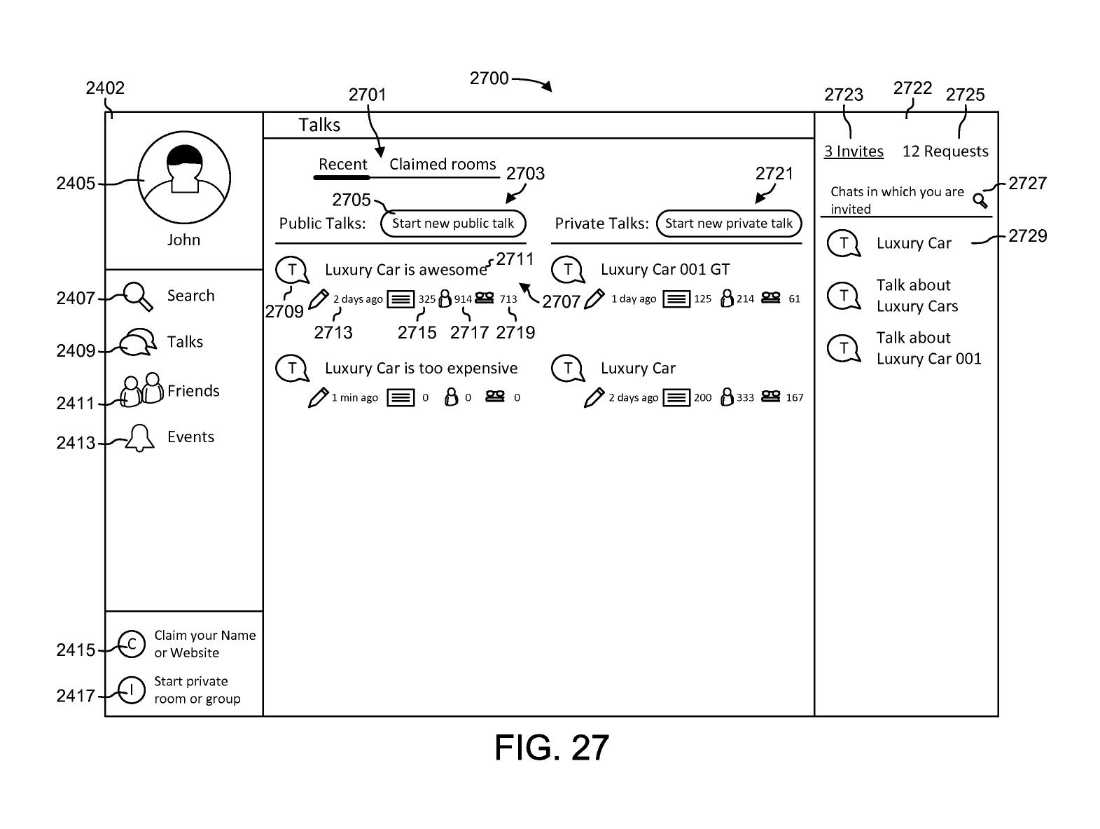

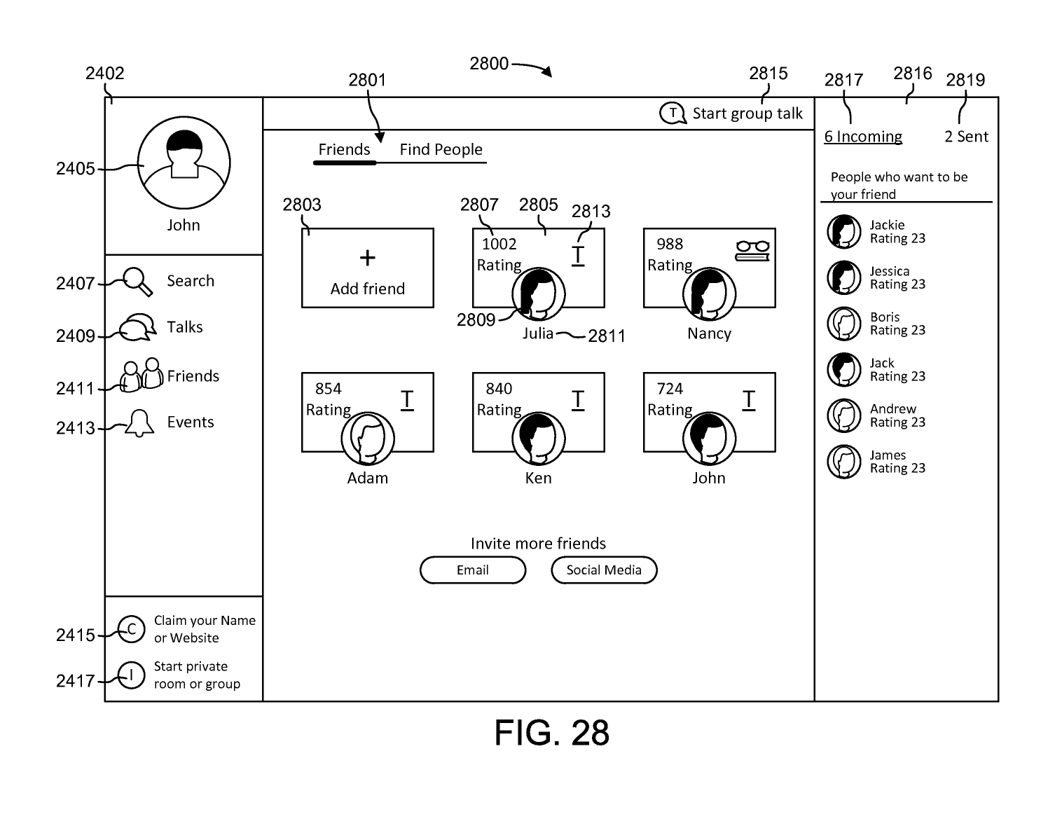

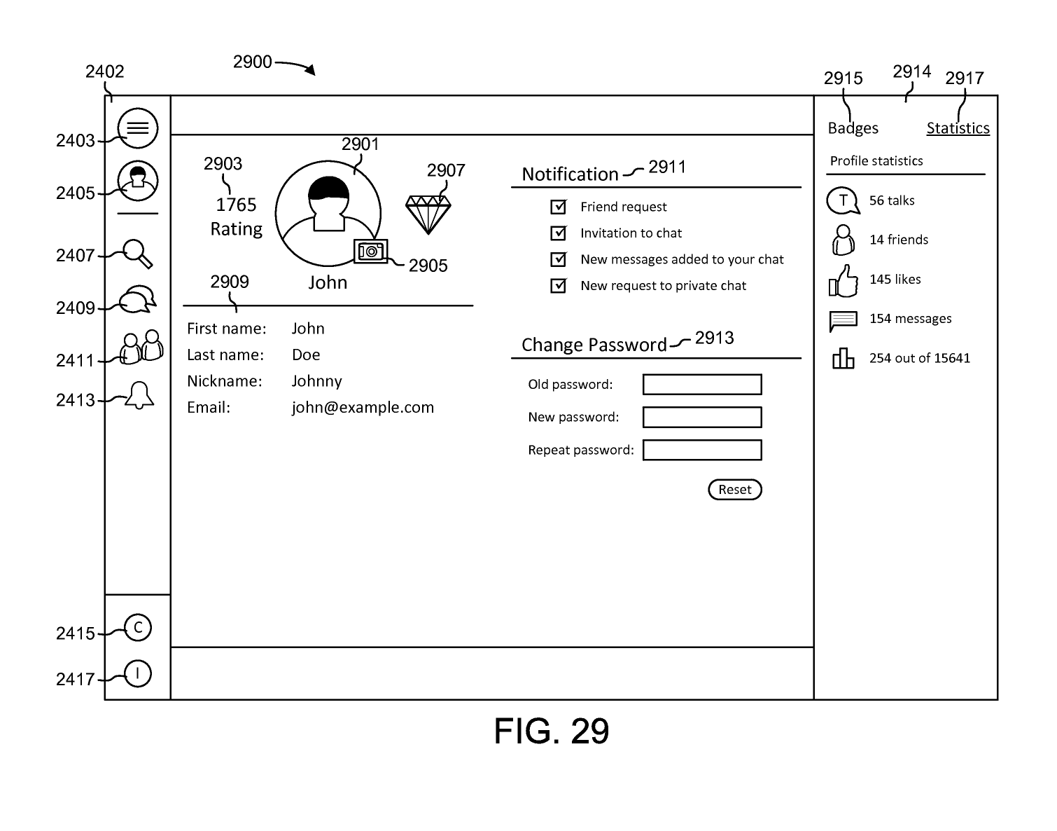

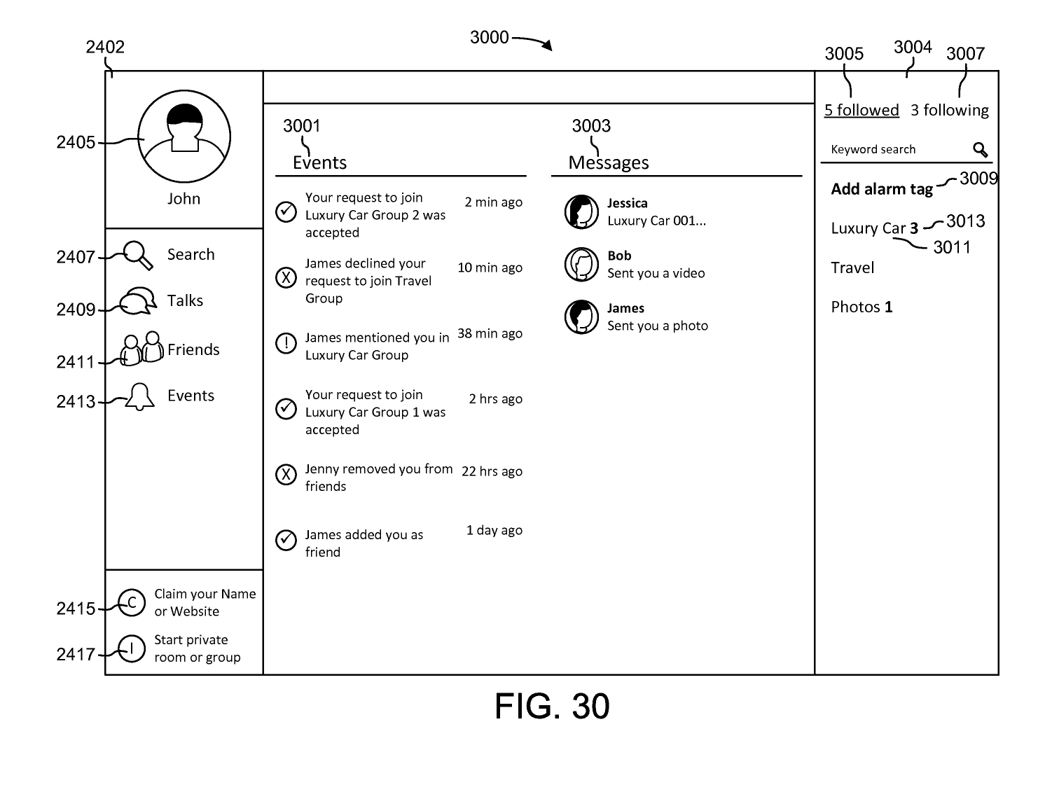

Home page 2400 includes navigation bar 2402. In some embodiments, navigation bar 2402 is included in all pages of the graphical user interface which the computer system causes to be displayed on the user device. Navigation bar 2402 includes menu button 2403. In some embodiments, menu button 2403 causes navigation bar 2402 to expand (e.g., as illustrated in FIG. 27) and include labels corresponding to the other buttons included in navigation bar 2402. Navigation bar 2402 further includes user profile button 2405. User profile button 2405 includes an image associated with the user profile stored in memory 308 of the computer system and provided to the user device for display in the graphical user interface. User profile button 2405, when clicked, causes the user device to transmit a request for user profile page 2900 (e.g., illustrated in FIG. 29) to the computer system. The computer system receives the request, using network interface 302, formats information and instructions for the display of user profile page 2900 and the content included therein using processing circuit 304, and transmits the instructions and content to the user device via network interface 302. Navigation bar 2402 further includes search button 2407. Search button 2407, when clicked, causes the user device to transmit a request for search results page 2500 (e.g., illustrated in FIG. 25) to the computer system. The computer system receives the request, using network interface 302, formats information and instructions for the display of search results page 2500 and the content included therein using processing circuit 304, and transmits the instructions and content to the user device via network interface 302. Navigation bar 2402 further includes chat button 2409. Chat button 2409, when clicked, causes the user device to transmit a request for chat page 2700 (e.g., illustrated in FIG. 27) to the computer system. The computer system receives the request, using network interface 302, formats information and instructions for the display of chat page 2700 and the content included therein using processing circuit 304, and transmits the instructions and content to the user device via network interface 302. Navigation bar 2402 further includes friends button 2411. Friends button 2411, when clicked, causes the user device to transmit a request for friends page 2800 (e.g., illustrated in FIG. 28) to the computer system. The computer system receives the request, using network interface 302, formats information and instructions for the display of friends page 2800 and the content included therein using processing circuit 304, and transmits the instructions and content to the user device via network interface 302. Navigation bar 2402 further includes events button 2413. Events button 2413, when clicked, causes the user device to transmit a request for events page 3000 (e.g., illustrated in FIG. 30) to the computer system. The computer system receives the request, using network interface 302, formats information and instructions for the display of events page 3000 and the content included therein using processing circuit 304, and transmits the instructions and content to the user device via network interface 302.

Navigation bar 2402 may further include claim button 2415. Claim button 2415, when clicked, causes the computer system to generate a graphical user interface page which includes fields prompting a user to input information for claiming a name or website that the user owns. The user may request that his profile be associated with the claimed name or website using the graphical user interface. The claim may be reviewed automatically by the computer system of by an operator of the computer system. When claimed (and approved), a website or name is associated with a particular user in memory 308 of the computer system (e.g., stored in a tuple). This may cause the computer system to display the user profile (e.g., user profile button 2405) associated with the claimed website or name when information associated with the claimed website or name is displayed by the graphical user interface. For example, if a claimed website is returned in search results, the user profile of the claimed owner may be displayed next to the website hyperlink in the search results and/or the user associated with the profile may be listed as an expert related to the website in an area of the graphical user interface displaying users associated with the search results and/or website (e.g., user list 2533 illustrated in FIG. 25).

Navigation bar 2402 may further include private group button 2417. Private group button 2417, when clicked, causes the computer system to generate a graphical user interface page which includes fields, buttons, and/or other elements which allow a user to create a private group or chat which is not visible to users who are not invited to join by the creating user (or in some cases other users who have joined the private chat or group).

In some embodiments, home page 2400 further includes recent searches field 2420. Recent searches field 2420 is generated on the user's device as part of the graphical user interface based on instructions and information provided to the user device by the computer system. In one embodiment, the computer system stores recent (e.g., the last predetermined number of searches) public searches from all users in memory 308. When home page 2400 is requests by a user device, the computer system causes recent searches filed 2420 to be generated based on the stored information. Recent searches field 2420 includes each set of search terms 2421. Clicking on search terms 2421 causes the user device to submit a search query to the computer system using those search terms. The computer system then causes the display of search results based on those terms on the user device. In some embodiments, clicking search terms 2421 reveals a button prompting the user to confirm that the search will be conducted prior to submitting the search query. Associated with the search terms 2421 is user profile button 2423 corresponding to the user who submitted the search query. Clicking on user profile button 2423 submits a request to the computer system to display the user profile associated with that user. The computer system receives an indication of which user profile button 2423 was clicked and causes the user device to display a page of the graphical user interface containing the associated user profile (e.g., based on information related to the user profile stored in memory 308). This page may include information about the user and/or options to interact with the user (e.g., friend the user, chat with the user, and/or other generate other interactions carried out by the computer system as described herein). In another embodiment, the computer system stores recent search queries submitted by the user in memory 308 associated with the user (e.g., as a tuple) and displays these recent searches conducted by the user in recent searches field 2420.

In some embodiments, home page 2400 further includes public search toggle 2419. When clicked, public search toggle 2419, causes the user device to transmit a request to the computer system to toggle the public search setting associated with the user. The computer system receives the request via network interface 302. The public search setting associated with the user is stored in memory 308. The computer system toggles the public search setting between on and off based on the request from the user device. When the public search setting is toggled on, search queries submitted by the user are visible to other users (e.g., visible in the recent searches field 2420 of their homepages 2400, visible in the user list 2533 of users searching related keywords in search results pages 2500 of other users, etc.). When the public search setting is toggled off, the computer system does not provide user information to other user devices when generating elements of the graphical user interface including information or identification of other users based on searches (e.g., recent searches field 2420 of their homepages 2400, user list 2533 of users searching related keywords in search results pages 2500, etc.).

Referring now to FIG. 25, search results page 2500 of the graphical user interface generated by the computer system instructions provided to the user device is illustrated according to one embodiment. The search result content, associated content (e.g., related chats, users searching for the same results, recent search results for similar keywords, and/or other associated content) and instructions for displaying this information are transmitted to the user device to cause the display of the graphical user interface in response to a user submitted search query and/or in response to a user clicking search button 2409 of navigation bar 2402. Search results page 2500 may also be accessed by a user by clicking on search button 2407 of the navigation bar 2402.

Search results page 2500 includes an indication 2501 of the searched terms. The computer system provides information to the user device of the terms in the search query which are then displayed as indication 2501 as part of the user device's generation of the graphical user interface based on the instructions from the computer system.

In some embodiments, search results page 2500 includes search results list 2503. Search results list 2503 includes an indication 2505 of the search engine used in performing the search. In some embodiments, a user may click on the indication 2505 to select a different search engine for use in searching for the query. In such a case, selecting a different search engine causes the user device to resend the search request with information indicating that a different search engine has been selected. The computer system receives the search request, conducts a search via the different search engine, and sends instructions to the user device causing search results page 2500 to be redisplayed according to the search results from the different search engine. Search results list 2503 may further include buttons 2507 which allow a user to toggle between the type of search and/or results displayed (e.g., search of websites, videos, news only, etc.). Toggling between the type of search may cause the search results page 2500 to be redisplayed by the computer system.

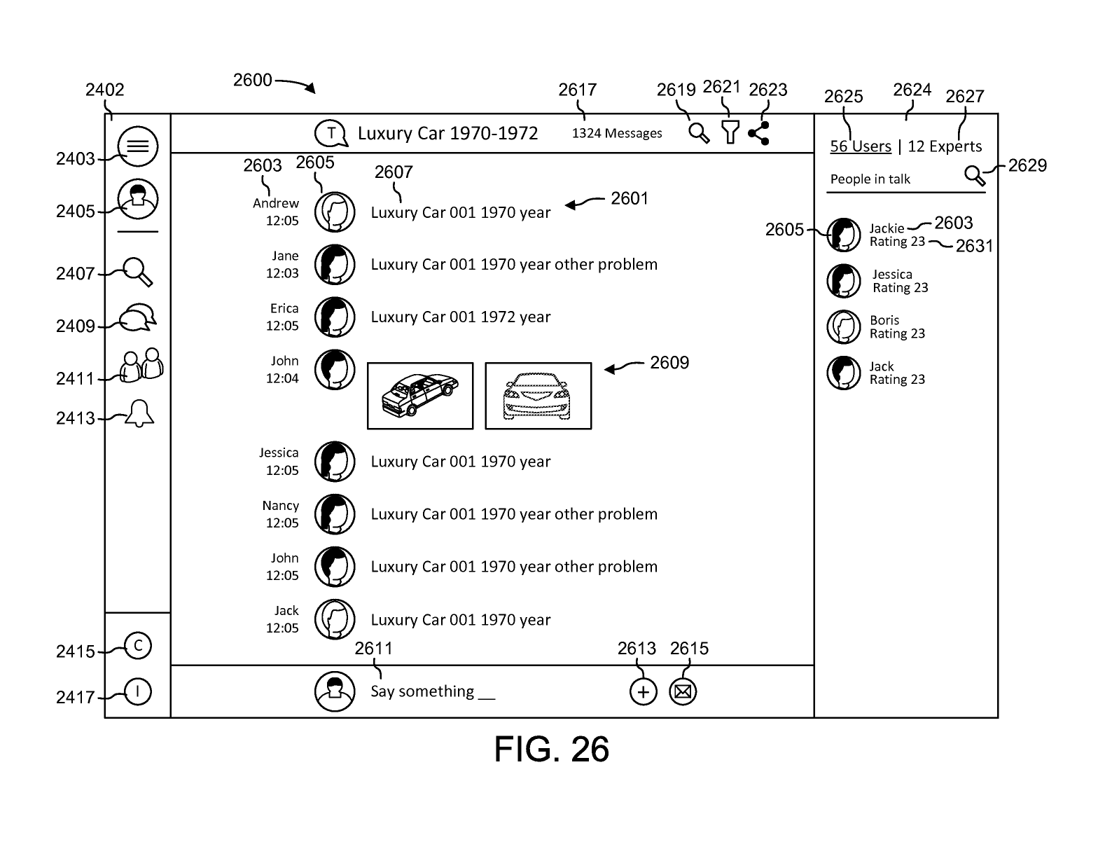

Search results list 2503 further includes a list of search results. Each search result may include one or more of a webpage title 2509, a universal resource locator address 2511, a description or excerpt of text found on the page 2513, a start talk button 2519, a first user who suggests the website 2515, and/or an indication of the number of other users who suggests the website 2517. The first user who suggests the website 2515 may be displayed based on information stored in memory 308 of the computer system. For example, the first user who suggest the website 2517 may be the user with the highest user rating who suggests the website, the user who has claimed ownership of the website, a friend of the user conducting the search, or a user who is designated an expert with regard to one or more keywords in or associated with the search result. This information and associations are stored and maintained by the computer system and provided to the user device in the instructions which cause the display of the search results page of the graphical user interface. The start talk button 2519, when clicked sends a request to the computer system for the generation of a chat session related to the website associated with the start talk button in the search results. In response to the request, the computer system provides instructions to the user device which generates a graphical user interface for the chat (e.g., as illustrated in FIG. 26). The chat session may be populated by the computer system automatically based on similar requests for chat sessions submitted by other users or may be populated in response to invites to other users requested to be sent by the user in the chat. In some embodiments, if a chat session already exists for the website, the computer system causes the user to join the chat in progress when the start talk button 2519 is clicked.

In some embodiments, a user may make comments about a website (e.g., certain universal resource locator address) related to a search result 2509 from the search results page 2500. The comments may automatically be posted in chat rooms/sessions which are related to the website and/or keywords associated with the search query and/or website. The comments may be entered in a field which is displayed when a user mouses over or selects a search result or icon associated with the search result. The computer system may receive the comment and based on information from the user device determine which website and/or keywords are related to the comment. Based on the related website and/or keywords, the computer system automatically causes the comment to be displayed in one or more relevant chat rooms/sessions. For example, chat rooms/sessions may be stored in memory 308 as a tuple with keywords and/or websites which correspond. The computer system may cross reference this information with the received information to determine which related chat rooms/sessions in which to post the comment.

The search results page 2500 may further include a talk list 2518. The talk list 2518 may include a start new talk button 2521. The start new talk button 2521 operates in a similar fashion to the start talk button 2519 discussed above. The start new talk button 2521 starts a new chat or causes the user to join an existing chat related to the search (e.g., one or more keywords included in the search). The talk list 2518 displays a list of chat sessions already in progress and/or already created which are related to one or more keywords contained in the search query (e.g., the chat title or chat content contains a predetermined number of keywords from the search query and/or related keywords). The keywords from the search query found in the title of the chat session may be bolded, color coded, underlined, or otherwise indicated in the chat session title 2523 displayed in the talk list 2518. Each entry in the talk list may include one or more of chat session title 2523, an indication of the time since the chat session has last been modified 2525 (e.g., a user has posted a comment), an indication of the number of users participating in the chat 2529, and/or an indication of the number of expert users participating in the chat 2531. A user can click on a listed chat session in order to join the chat session (e.g., a request is sent to the computer system which sends instructions to the user device to display the chat session). In some embodiments, the first chat listed in the talk list 2518 is a chat based on the location of the user device. The user device may provide location information (e.g., GPS coordinates, IP address, and/or other location information) to the computer system as part of sending a search query. The computer system may use the location information to generate the chat based on this location data to include other users within a predetermined area or distance from the user. This location based chat may be further restricted to users searching for the same or similar keywords. Alternatively, this location based chat session may include nearby users irrespective of the keywords being searched by these users. Advantageously, this allows users to easily identify other users in the same area with which to chat.

In some embodiments, search results page 2500 includes user list 2533. User list 2533 includes a list of users searching for the same or similar keywords. User list 2533 is generated based on instructions from and information stored in the computer system. For example, the computer system may maintain a database of all recent searches conducted by users organized as tuples of users and keywords. When a search query is received from a user and prior to generating the search results page 2500, the computer system may process the search query to identify one or more keywords. Based on the identified keywords, the computer system cross references the identified keywords with the database of recent searches to identify users searching for similar keywords. The user names 2539 and associated profile pictures are sent to the user device along with the instructions for generating the search results page 2500. In some embodiments, 10 users searching for similar keywords are displayed in user list 2533 by default. The user list 2533 may be scrolled to view additional users. In other embodiments, other numbers of users are displayed by default. Advantageously, users searching for similar keywords are automatically displayed to a user alongside the results of the user's search. A user is not required to setup an alert or other notification request for user's searching for similar search results. The list of users searching for similar keywords allows a user to quickly and easily identify other users which whom to chat about the search.

For each user displayed in the user list 2533, the username 2539, online status 2541, user rating 2543, number of comments made by the user 2545, time at which the user last commented 2547, and/or other information is displayed. When a listed user in the user list 2533 is clicked, the graphical user interface displays an option to initiate a private chat with the selected user (e.g., transmit a private chat request to the user). When this option is selected (e.g., clicked) the user device sends a request to the computer system which transmits a request for a private chat to the user device associated with the second user with whom the first user wants to chat. In some embodiments, clicking on the profile picture or name of the user in the user list 2533 causes the computer system to display the profile of that user. In some embodiments, the option for initiating a private chat is displayed when a user mouses over the listed user in user list 2533. In some embodiments, when a user clicks on or mouses over a user in the user list 2533, an excerpt of the listed user's last post related to the one or more keywords in the search query is displayed in place of the statistical information related to the listed user.

In some embodiments, the user list 2533 includes tabs which organize the users in the user list 2533. Selection of a first tab 2535 may cause the user list 2533 to display users searching for similar keywords as described above. A second tab 2527, when clicked, may cause the user list 2533 to display a list of expert users who are associated with the keywords contained in the search query. A list of experts identified with each keyword is maintained by the computer system (e.g., stored in memory 308). A user may become an expert associated with a keyword in a variety of manners. For example, a user may be identified by the computer system as an expert associated with a keyword if the user claims a website or name associated with the keyword. In some embodiments, a user may become an expert user associated with a keyword by receiving a predetermine number of up votes for comments made in chat sessions associated with a keyword. In further embodiments, a user may become an expert with respect to a particular keyword by applying to be one through the computer system. In still further embodiments, a user may indicate that he or she wishes to become an expert for a keyword and may send requests to friends or other users to identify him or her as an expert. Upon receiving a predetermined number of identifications, the user is identified as an expert with respect to that keyword by the computer system. In still further embodiments, a user can self-designate as an expert by providing keywords to the computer system (e.g., via the graphical user interface) for which the user wants to be identified as an expert.

In some embodiments, the users displayed in user list 2533 (e.g., in first tab 2535) are displayed based on location. For example, only users who are searching for similar keywords and who are located within a predetermined distance from the user are displayed. In some embodiments, only expert users are displayed under the second tab 2537 who are within a predetermined distance from the user searching or are within a predetermined area in which the user searching is located (e.g., within the same metropolitan area, the same state, the same country, the same county, the same city, and/or other area). The location of the experts may be determined based on location data received by the computer system when expert users use the computer system, based on information contained in their profile (e.g., where they live or work), based on business addresses associated with businesses, websites, or names which the expert user has claimed, and/or based on other information. In other embodiments, experts identified with the one or more keywords contained in the search query are displayed in the second tab 2537 regardless of the area in which the experts are located or their distance from the searching user.

In some embodiments, search results page 2500 includes recent results field 2420. Recent results field 2420, while displayed on the search results page 2500, includes recently active chat rooms which are related to one or more keywords contained in the search query. Chat rooms may be designated by the computer system as recently active based on one or more factors such as a comment being posted within a predetermined time period, the chat session or group being created within a predetermined time period, and/or other factors. When a search query is received from a user device, the computer system may determine the keywords contained in the search query and compare them to a database of recently active chat sessions or groups corresponding with the identified keywords. Included in the instructions and information provided to the user device from the computer system may be instructions and information which cause the user device to display the recently active chat sessions in the recent results field 2420. When a user clicks or mouses over a listed currently active chat 2549, the user is prompted to join the chat session, and can click to accept or decline. Based on the selected option, the user device provides the computer system with instructions on generating a chat session (e.g., as illustrated in FIG. 26).

Referring now to FIG. 26, chat page 2600 of the graphical user interface generated by a user device according to instructions from the computer system is illustrated according to one embodiment. The chat page 2600 may be generated and be caused to be displayed by the computer system based on the occurrence of one or more of the actions previously described herein. For example, a user may click an option to join a chat session presented on the search results page, a user may select an option to start a new chat session (e.g., an option found in navigation bar 2402 or search results page 2500), or otherwise provide an instruction to the computer system, via an input of the graphical user interface, to join or create a chat session. The computer system includes interactive chat module 312 to facilitate and perform the functions of the chat described herein throughout.

Chat page 2600 includes a header which in turn includes the title of the chat session or room. The header may also include one or more of an indication of the number of messages/comments in the chat session 2617, a search button 2619, a filter button 2621, and/or a share button 2623, a. In some embodiments, clicking the title or an associated icon in the header displays options to allow a user to see members associated with a group linked to the chat session, claim the name of the chat group/session, and/or minimize the chat session.

Clicking the search button 2619, causes the graphical user interface to display a search field. When a user enters text through the search filed, the computer system searches the messages in the chat session for messages containing the search terms and causes the user device to display a graphical user interface with the search results displayed. Clicking the filter button 2621 causes the graphical user interface to display a filter command bar with options (e.g., buttons, sliders, fields, etc.) to filter the messages/comments in the chat session by whether the message/comment contains a picture or video, whether the message/comment has a rating higher than a certain value, the source of the message (non-friend users, friend users, anonymous users, all users, etc.), the date of the message, and/or by other characteristics of the message. Filtering may be carried out by the computer system based on the filter properties selected in the graphical user interface and received at the computer system. Based on the filter parameters, the computer system may provide instructions to the user device to display an updated and filter list of chat messages/comments. Clicking the share button 2623 causes the graphical user interface to display options to share a link to the chat session via e-mail, social networks, messaging systems, and/or other communication services. Clicking an option causes the graphical user interface to display login options for the service, or alternatively if the user is already logged in or the computer system has stored the login information for use, displays a confirmation button to transmit a link to the chat session. Once a user has logged in, the user is given the option to confirm to share the link and/or options on how the link will be shared using the other communication service.

In some embodiments, chat page 2600 includes chat participant list 2624. Chat participant list 2624 lists all the users which are in the chat session/room. For each user, the participant list 2624 includes a profile picture icon 2605, user name 2603, and user rating 2631. When a user mouses over or clicks on a user listed in participate list 2624, an option is displayed which when selected invites the listed user to a private chat session with the first user. The user rating may be calculated and stored by the computer system based on one or more factors such as length of time a user has been a participant in the system run by the computer system; amount of posts, messages, and/or comments made by the user; frequency of posts, messages, and/or comments made by the user; number of friends the user has, number of keywords the user is an expert in; number of times posts, messages, and/or comments made by the user are up voted or down voted; and/or other factors.

In some embodiments, chat participant list 2624 includes a first tab 2625 which when selected displays all users in the chat session and a second tab 2627 which when selected displays expert users in the chat session. Each tab may also list the number of that type of user currently in the chat session. In some embodiments, chart participant list 2624 further includes search button 2629. When selected, search button 2629 causes the display of a field which allows a user to search the list of other users in the chat session for a particular user.

Chat page 2600 displays messages 2601 (e.g., comments or posts) from users. Each message 2601 may include a user name 2603 corresponding to the user who posted the message, the time the message was posted, a user profile picture 2605 corresponding to the user who posted message 2601, and/or the content of the message 2607. In some embodiments, the content of the message 2607 may include one or more images 2609, videos, files, and/or text. Text for a message 2601 is entered by a user via message field 2611. The text and/or other content may be posted as a message 2601 when the user presses the enter key or clicks on send button 2615. When a user clicks on add file button 2613, message field 2611 becomes a drag and drop target which allows a user to upload files by dragging and dropping them into message field 2611.

In some embodiments, a user can mouse over message 2601 to reveal additional options. For example, when a user mouses over message 2601 icons allowing for a user to reply to the user who originated the message 2601, up vote the message 2601, down vote the message 2601, flag the message 2601 as violating the terms and services of the computer system, and/or allowing for other actions are displayed. When an icon is selected, the user device transmits the corresponding information to the computer system which tracks the information and updates the graphical user interface for all users accordingly.

In some embodiments, messages 2601 which contain other keywords are automatically posted in other relevant chat rooms/sessions when submitted in one chat room/session using message filed 2611. The message 2601 is transmitted to the computer system which then causes the graphical user interfaces of other user devices to be updated to reflect the message 2601. The computer system uses interactive chat module 312 to format instructions to be sent to the user devices of other users in the chat session. The instructions cause the content of message 2601 to be displayed in the graphical user interfaces of the other user devices. The computer system may analyze received message content to determine if other relevant keywords are contained in the message content and may automatically cause the message 2601 to be displayed in other relevant chat rooms/sessions based on the keyword content of the message.

Referring now to FIG. 27, talks list page 2700, as generated on a user device according to information and instructions provided by the computer system, is illustrated according to one embodiment. The talks list page 2700 is caused to be displayed on the user device by the computer system when the user clicks the talks button 2409 on navigation bar 2402. Clicking talks button 2409 causes the user device to request the page from the computer system. In response, the computer system sends instructions and information to the user device to cause the display of talks list page 2700. The computer system stores in memory 308 the chat rooms/sessions in which the user has commented or posted a message. This information is used along with the transmitted instructions to cause the user device to generate talks list page 2700 which lists all, or in some embodiments a subset (e.g., recently commented in chat rooms/sessions), in which the user has commented (e.g., posted a message).

Chat list page 2700 may display chat rooms/sessions in which the user has commented under one or more tabs 2701. For example, one tab may correspond to, and when selected display in the graphical user interface, chat rooms/sessions in which the user has recently posted a message or otherwise commented. In some embodiments, selection of another tab causes the display of chat rooms/sessions corresponding to a claimed website, name, or group which the user has claimed. In some embodiments, selection of a third tab causes the display of all chat rooms/sessions in which the user has posted a comment (e.g., a message).

In some embodiments, chat sessions displayed under each tab are organized into a first column 2703 showing public chat sessions in which the user has commented and a second column 2721 showing private chat sessions in which the user has commented (e.g., chat sessions in which there are only two participants, the user and a second user). In each column a start new talk button 2705 is included which, when selected, causes the computer system to initiate a new chat session, public or private depending on which start new talk button 2705 is selected.

Each talk (e.g., chat session) 2707 may be listed with the title of the talk 2711, an indication of the last time a message or comment was posted in the chat session 2713, an indication of the total number of messages or comments posted in the chat session 2715, an indication of the total number of users which have posted in the chat session 2717, and/or an indication of the total number of expert users participating in the chat session 2719. Each talk listed may also be listed alongside a chat icon 2709 which when selected causes the display of the chat page 2600 corresponding to the listed talk 2707.

In some embodiments, the chat list page 2700 includes a chat management pane 2722. Chat management pane 2722 lists invitations for the user to participate in existing chats under invites tab 2733. Each chat may be listed with the title of the chat 2729. When a user clicks, or in some embodiments mouses over a listed chat 2729, the graphical user interface displays an accept and a reject button which when clicked accept the invitation and cause the user to join the chat and reject the invitation, respectively. Search button 2727, when clicked, causes the display of a search field which allows a user to search the content of the listed chat sessions 2729. Chat management pane 2722 may also list outstanding requests by the user to join existing groups or chat sessions under requests tab 2725. Requests may be similarly listed and/or searched.

Referring now to FIG. 28, friends page 2800, as generated by a user device according to instructions and/or information provided by the computer system, is illustrated according to one embodiment, Friends page 2800 is caused to be displayed when a user selects friends button 2411 from navigation bar 2402. The computer system maintains a database of the other users who are friends of the user (e.g., stores the database in memory 308). The computer system updates the friends database as instructions are received from users devices on which users accept friend requests. The instructions are received via network interface 302 and processed using processing circuit 304.

In some embodiments, friends page 2800 includes two tabs 2801 corresponding to existing friends and friend recommendations. The recommendations tab may be labeled “find people.” When a user selects this tab, the graphical user interface is updated to include information about other users who are not already friends with the user. For example, the information displayed may be suggests of other users with whom the user may desire to be friends. This list may be generated using a plurality of factors such as determining friends of a user's existing friends, users who participate in a predetermined number of chat sessions in which the user also participates, cross reference of profile information between the user and the other users, close geographic location of the user and the other users, and/or other factors. The computer system may carry out the analysis of other users and determine whether to list them on the graphical user interface using processing circuit 304. A user may select listed users to view additional information about the user and/or send a friend invite to the other user.

Under the tab corresponding to existing friends, the graphical user interface displays a list of the user's existing friends. This database is maintained by the computer system (e.g., stored in memory 308 and updated based on instructions received via network interface 302). The list of existing friends may be made up of individual friend listings 2805. Each friend listed 2807 may include may include a profile picture 2809 of the user, name of the user 2811, and user type icon 2813. The user type icon 2813 may indicate information about the user such as whether the user is a new user (e.g., user type icon 2813 is an underlined “T”) or an expert user (e.g., user type icon 2813 is a pair of glasses over a book). In further embodiments, other user types (e.g., experienced user, moderator, etc.) may be indicated with further user type icons 2813. In some embodiments, when a user mouses over a listed friend 2807 a plurality of options may be displayed which allow a user to unfriend the friend, being a private message (e.g., chat session) with the friend, invite the friend to a group, block the friend, report the friend, or take other action. In some embodiments, friends page 2800 includes add friend button 2803 which, when selected, causes the graphical user interface to display options for adding a friend (e.g., searching for a user name and adding a selected user). In some embodiments, friends page 2800 includes a start group chat button 2815 which, when selected, prompts a user to select friends to be included in a group chat session and causes the user device to transmit and instruction to the computer system to initiate the group chat session with the selected users. The computer system creates the group chat session using interactive chat module 312.

In some embodiments, friends page 2800 includes a friend invite management pane 2816. Friend invite management pane 2816 lists friend invitations the user has received under invites tab 2817. Each invite may be listed with the name and profile picture of the user requesting to be friends with the user. When a user clicks, or in some embodiments mouses over a listed friend invite, the graphical user interface displays an accept and a reject button which when clicked accept the invitation and cause the computer system to add the users to their respective friends database t and reject the invitation, respectively. Friend invite management pane 2816 may also list outstanding friends requests by the user to other users under sent requests tab 2819. Requests may be similarly listed with the user name and user profile of the users to which friend requests have been sent.

Referring now to FIG. 29, user profile page 2900, as generated by instructions and/or information received at a user device from the computer system, is illustrated according to one embodiment. User profile page 2900 may be displayed when a user clicks user profile button 2405. User profile page 2900 includes options for modifying the settings of the computer system with respect to the user and/or viewing information about the user stored by the computer system. In some embodiments, user profile page 2900 includes the profile picture 2901 associated with the user and stored on the computer system, a user rating 2903 maintained by the computer system, and/or a user type icon 2907. The user rating may be influenced by the factors described herein (e.g., number of user comments which have been up voted or down voted and number of votes, expertise with respect to keywords, claimed websites, number of friends, etc.) and/or other factors. The user type icon 2907 is determined based on the factors described herein (e.g., user type, expertise, etc.) and/or other factors. User profile page 2900 includes picture button 2905 which allows a user to upload a new profile picture to the computer system.

The profile page 2900 lists the user's personal information including name, nickname, e-mail, and/or other information. A user may change privacy settings which control to which other users this information is available by selecting the privacy icon 2909 which corresponds to each piece of information. Settings are conveyed using different icons and may include visible to all, visible to friends only, visible only to the user, visible to registered users of the computer system, and/or other settings. The profile page 2900 may further include options 2911 for controlling notifications which are sent to the user device by the computer system upon the occurrence of certain events (e.g., the user receiving a friend request, the user receiving an invitation to chat, a new message being posted in a chat session in which the user is participating, the user receiving a new request for a private chat, and/or other events). The profile page may further include options 2913 for managing a user's password.

In some embodiments, the profile page 2900 further includes profile information pane 2914. Profile information pane 2419 may display further information about the user under one or more tabs. In some embodiments, information pane 2914 includes badged tab 2915 which when selected displays the badges that the user has earned through achieving certain achievements (e.g., making a first post or comment, becoming friends with a predetermined number of users, becoming an expert, etc.). In some embodiments, information pane 2914 includes statistics tab 2917 which displays statistics about the user. For example, the statistics displayed may include the number of talks (e.g., chat sessions) the user has joined, the number of friends the user has, the number of likes or up votes the user's posts or messages have received, the number of messages the user has posted in chat sessions, a ranking in comparison to other users based on the user's rating, and/or other statistics.

Referring now to FIG. 30, events page 3000, as generated by a user device according to instructions and information from the computer system, is illustrated according to one embodiment. In some embodiments, events page 3000 lists events 3001 which have occurred. For example, the listed events may include friend requests being accepted or declined by other users, mentions of the user by other users, invitations to chat sessions, being unfriended by other users, and/or other events. The listed events may be listed in chronological order. In some embodiments, events page 3000 includes message list 3003 which chronologically lists messages sent to the user. The messages may be in private chats in which the user participates and/or replies to messages that a user has posted in a chat session (e.g., a public talk).

In some embodiments, events page 3000 further includes alarms panel 3004. Alarms panel 3004 includes options and information related to talks (e.g., chat sessions) which the user is following or in which the user participates and other users are following. These options and/or information may be organized under tabs 3005 and 3007, respectively. Under followed tab 3005, add alarm tag button 3009 is displayed. When a user clicks add alarm tag button 3009, a user may select a chat session to follow. The user may select from a list of recent chat sessions in which the user has participated or viewed. In some embodiments, a user may also follow a chat session by typing and submitting as a message the word “tag,” which causes the computer system to add the chat session to the list of chat sessions the user is following. In some embodiments, the word tag does not appear as a visible message to other users in the chat session. The computer system receives the message, identifies the content as “tag” and rather than causing the message to be displayed, identifies the chat session and the user sending the “tag” message and adds the chat session to a database of followed shat sessions for that user. The computer system determines when new messages are received in the followed chat sessions and provides this information to the user device such that it is displayed on events page 3000 in alarms panel 3004. For example, a user's followed chat sessions are displayed by name 3011 and include an indication 3013 of the number of new messages which have been posted since the user last viewed the chat session. Notifications may also be sent to the user. Similar information may be provided under following tab 3007 for chat sessions in which the user is participating and which other users are following. A user may click on a listed chat session, or is some embodiments mouse over the listed chat session, to cause the display of an option to stop following the chat session. When selected, an instruction is sent from the user device to the computer system which causes the computer system to remove the chat session from the database of followed chat sessions.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer system, comprising:
a network interface configured to communicate with a plurality of user devices and at least one server implementing an internet search engine;
memory configured to store information related to a plurality of users of the computer system;
an interactive chat module stored in memory and configured to be executed to establish chat based communication between a first user of the computer system and at least a second user of the computer system;
a search engine module stored in memory and configured to be executed to provide search queries received at the computer system to remote search engines and further configured to process received search results from the remote search engine; and
a processor configured to:
receive a search query from a graphical user interface of the first user running on a first user device of the plurality of user devices, the search query received at the network interface and provided to the processor;
format the search query and transmit the search query to at least one remote search engine using the network interface and according to the search engine module;
receive search results from the search engine via the network interface and format instructions for the display of the search results in the graphical user interface of the first user;
transmit, using the network interface, the instructions to the first user device for the display of the search results in the graphical user interface and wherein the instructions include instructions for the display of a chat option on the graphical user interface to chat with one or more other users based on the search query; and
transmit, using the network interface, further instructions formatted through execution of the interactive chat module to cause the display of a chat session between the user providing the search query and the one or more other users based on a user selected chat option,
wherein the chat option includes an option to chat with other users of the computer system which are located within a predetermined distance from the first user, and wherein the chat option identifies other users who are designated experts by the computer system which respect to one or more keywords included in the search query of the first user.

2. The computer system of claim 1, wherein the chat option includes both (A) a list of chat sessions having titles including at least one keyword included in the search query and (B) a list of other users who have submitted other search queries to the computer system including at least one keyword included in the search query received from the first user, and wherein the list includes other users whose submitted search queries were submitted within a predetermined time period before the reception of the search query of the first user.

3. The computer system of claim 2, wherein the list of other users who have submitted other search queries to the computer system including at least one keyword included in the search query received from the first user includes ten users by default.

4. The computer system of claim 1, wherein the instructions are configured to cause the display of the chat option including the identification of other users who are designated experts by the computer system irrespective of whether the expert users are within the predetermined distance from the first user.

5. The computer system of claim 1, wherein the processor is further configured to:
receive, via the network interface and from the first user device, a message for posting in the chat session between the user providing the search query and the one or more other users based on the user selected chat option;
process the received message to identify keywords included in the message;
send instructions, via the network interface, to user devices associated with the one or more other users to cause the display of the message; and
send instructions, via the network interface, to cause the display of the received message in other chat sessions which are related to the identified keywords included in the message.

6. A computer-implemented method, comprising:
receiving, at a network interface of a computer, a search query from a user via a graphical user interface running on a user device as implemented according to instructions sent from the server to the user device via the network interface;
identifying keywords included in the search query and formatting the search query for transmission to one or more remote servers implementing a search engine using a search engine module included in the computer;
transmitting to the one or more remote servers implementing a search engine the formatted search query using the network interface;
receiving, using the network interface, search results from the one or more remote servers implementing a search engine;
transmitting, using the network interface, instructions to the user device for the display of the search results in the graphical user interface and wherein the instructions include instructions for the display of at least one chat option on the graphical user interface to chat with one or more other users based on the search results and based on the identified keywords included in the search query; and
receiving, using the network interface, a user selection of a chat option from the user device; and
transmitting, using the network interface, further instructions to the user device, the further instructions formatted through execution of the interactive chat module by the computer to cause the display of a chat session between the user and one or more other users based on the user selected chat option,
wherein the chat option includes an option to chat with other users of the computer system which are located within a predetermined distance from the first user, and wherein the chat option identifies other users who are designated experts by the computer system with respect to the identified keywords included in the search query.

7. The method of claim 6, wherein the chat option includes both (A) a list of chat sessions having titles including at least one keyword included in the search query and (B) a list of other users who have submitted other search queries to the computer including at least one keyword included in the received search query, and wherein the list includes other users whose submitted search queries were submitted within a predetermined time period before the reception of the search query of the first user.

8. The method of claim 7, wherein the list of other users who have submitted other search queries to the computer system including at least one keyword included in the received search query includes ten users by default.

9. The method of claim 8, wherein the instructions are configured to cause the display of the chat option including the identification of other users who are designated experts by the computer system irrespective of whether the expert users are within the predetermined distance from the first user.

10. The method of claim 9, further comprising:
receiving, using the network interface and from the user device, a message for posting in the chat session between the user providing the search query and the one or more other users based on the user selected chat option;
processing the received message to identify keywords included in the message;
sending instructions, using the network interface, to other user devices associated with the one or more other users to cause the display of the message; and
sending instructions, using the network interface, to cause the display of the received message in other chat sessions which are related to the identified keywords included in the message.
